(19) United States
(12) Patent Application Publication
(10) Pub. No.: US 2025/0299538 A1
(43) Pub. Date: Sep. 25, 2025

(54) RANDOMIZING DEVICE CORRELATED BINGO SYSTEM

(71) Applicant: LNW Gaming, Inc., Las Vegas, NV (US)

(72) Inventors: Dougal AUSTIN, Reno, NV (US); Brett GOTTIER, Reno, NV (US); Keshav PITANI, Reno, NV (US); Qiaofeng YANG, Reno, NV (US)

(21) Appl. No.: 19/086,339

(22) Filed: Mar. 21, 2025

Related U.S. Application Data
(60) Provisional application No. 63/568,469, filed on Mar. 22, 2024.

(51) Int. Cl. G07F 17/32; G06F 7/58

(52) U.S. Cl. CPC G07F 17/329; G06F 7/588; G07F 17/3211; G07F 17/3267

(57) ABSTRACT

A method and/or system to determine, based on a selected bet pattern in a wagering game and based on a prize pattern index, an interim prize pattern for bingo game. The prize pattern index correlates possible outcome patterns of a randomizing device, according to rules of the wagering game, to one or more index values within a matrix patterned according to a bingo card grid. The interim prize pattern is superimposed onto a set of bingo cards that use the grid. An outcome pattern for a randomizing device is detected and converted to interim ball draw(s) for the bingo game. The operations further mark (e.g., animate) index positions on the set of bingo cards that correspond to locations of mapped index values for the detected outcome pattern. The operations further mark (e.g., animate) the set of bingo cards and determine whether an interim prize value is awarded.

### CROSS-REFERENCE TO RELATED APPLICATION(S)

This patent application claims priority benefit of U.S. Provisional Patent Application No. 63/568,469 filed Mar. 22, 2024, the disclosure of which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### FIELD

The present disclosure relates generally to gaming systems, apparatus, and methods and, more particularly, to presentation and control of a bingo game system.

### BACKGROUND

For Class II purposes, United States code describes bingo as a “game of chance . . . with cards bearing numbers or designations . . . in which the holder of the card covers such numbers or designations when objects, similarly numbered or designated, are drawn or electronically determined, and . . . the game is won by the first person covering a previously designated arrangement of numbers or designations on such cards.” 25 USC § 2703.

Traditional bingo games use paper bingo cards with either manual or automated ball-draw systems. Players buy a bingo card or cards, and when the minimal number of players as determined by the bingo hall or casino are ready to play (can be on the order of twenty players per game, but varies widely), the current bingo session is considered closed; players subsequently purchasing cards will play in future game sessions. Those players having purchased cards for the current bingo game session will participate in the game about to start. Participating players watch as a sequence of bingo balls is drawn. The players daub (mark) their cards in squares or spaces corresponding to the balls drawn (alternatively, an electronic card version may be auto daubed). After a player daubs a pre-specified winning pattern on their card(s) and declares they have won by calling out “bingo,” the current game is typically considered over.

Class II bingo systems traditionally are central determination systems where a bingo server generates bingo cards and determines bingo ball draws for a bingo game. The bingo server sends the bingo cards and provides ball draw information to a slot machines, which then determine bingo outcomes (for the bingo cards based on the ball draws). The slot machines then derive a slot outcome based on the bingo outcome. This provides a slot outcome reversed mapped from a bingo outcome.

In at least one traditional central determination system, two players at two separate gaming machines/terminals compete against each other in the bingo game, each having a 50% chance of winning the bingo game. If a player wins, then the gaming machine/terminal maps the win to an equivalent slot game win outcome. However, one challenge is that at least two players must play against each other, and so one player must wait for another to join in the bingo game before the game can commence. Furthermore, because of the 50% chance of winning of the bingo game, the native hit frequency for the underlying Class III entertainment mechanism (e.g., the slot machine) needs to be translated to match that of the bingo game, which translating can change an underlying “feel” of the Class III mechanism. Another traditional system permits multiple players (beyond two) to buy into the bingo game (e.g., to buy game cards) that provides the same specific pattern to be filled out on the card via a certain number of random ball draws. However, the bingo specific patterns are equivalent for each player and, although consistent in appearance, provides no form of customization or variation for any given player in terms of appearance or bingo game function. Thus, a player may be less incentivized to play a bingo game using conventional bingo systems. In addition, for other types of casino games, such as table games, there has traditionally been no integration with a bingo game system.

A need therefore exists for a bingo gaming system and method that overcomes one or more of the foregoing shortcomings and/or that provides new and improved methods or systems to provide a bingo-correlated game with almost any type of game available in a casino.

### SUMMARY

According to one embodiment of the present disclosure, a method and/or system is described herein to perform operations to manage a bingo-based system that detects and uses outcomes of a randomizing device (e.g., a physical set of dice, a roulette wheel, etc.). For example, the operations determine, based on a selected bet pattern in a wagering game and based on a prize pattern index, an interim prize pattern for an associated bingo game. The prize pattern index correlates a set of possible outcome patterns of a randomizing device to one or more index values of a matrix constructed according to a known bingo card grid. The set of possible outcome patterns is predetermined based on the rules of the wagering game and based upon physical properties of the randomizing device. The interim prize pattern is superimposed onto the set of bingo cards. An outcome pattern for a randomizing device is detected and converted (e.g., via a mapping of the prize pattern index) to one or more interim ball draws for the bingo game. The operations further mark index positions on the set of bingo cards that correspond to locations of the mapped index values for the detected outcome pattern. The operations further mark the set of bingo cards and determine whether an interim prize value is awarded. In one example, an animation of the interim prize award is generated and displayed based on the selected bet pattern.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming system 100 according to at least some aspects of the disclosed concepts.

FIG. 2 is a schematic block diagram of a gaming system architecture 200 according to at least some aspects of the disclosed concepts.

FIG. 3 is a block diagram of a bingo game system according to at least some aspects of the disclosed concepts.

FIG. 4 is front-view illustration of an electronic gaming machine used in a bingo game system according to at least some aspects of the disclosed concepts.

FIG. 5 is a schematic block diagram of a gaming system 500 for implementing embodiments of waging games in accordance with at least some aspects of the disclosed concepts.

FIG. 6 is a block diagram of a computer 600 for acting as a gaming system for implementing embodiments of wagering games according to at least some aspects of the disclosed concepts.

FIG. 7 is a flowchart for controlling interim bingo features according to at least some aspects of the disclosed concepts.

FIG. 8-12 are diagrams of controlling one or more interim bingo features according to at least some aspects of the disclosed concepts.

FIG. 13-18 are diagrams of controlling one or more interim bingo features according to at least some aspects of the disclosed concepts.

FIG. 19-22 are diagrams of controlling one or more interim bingo features according to at least some aspects of the disclosed concepts.

FIG. 23 is a schematic block diagram of a table for implementing wagering games including a live dealer video feed according to at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

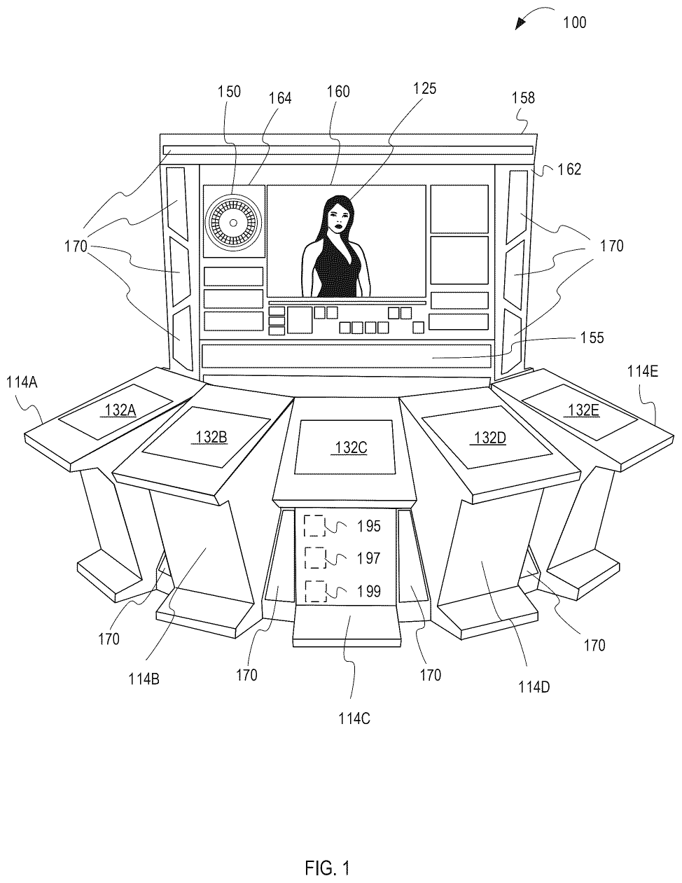

FIG. 1 is a perspective view of a gaming system according to at least some aspects of the disclosed concepts. One example of the gaming system 100 is described in U.S. patent application Ser. No. 17/948,755, filed Sep. 20, 2022 (i.e., the “Ser. No. 17/948,755 application”), and in U.S. patent application Ser. No. 17/948,633, filed Sep. 20, 2022 (i.e., the “Ser. No. 17/948,633 application”), which Ser. No. 17/948,755 application and Ser. No. 17/948,633 application are each incorporated by reference herein in their respective entireties. All patent applications, patents, and printed publications cited herein are incorporated herein by reference in their entireties, except to the extent that the incorporated material is inconsistent with the express disclosure herein, in which case the language in this disclosure controls.

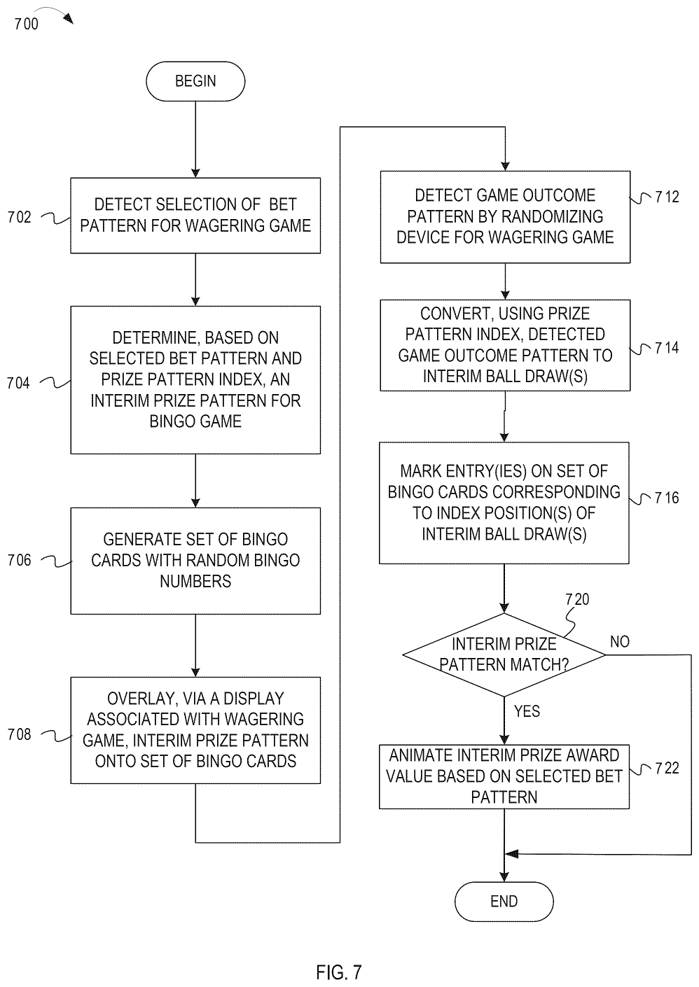

The gaming system 100 includes player terminals 114A through 114E that are arranged in a bank around a video device 158. The video device 158 includes a randomizing device screen 164 to present an outcome of a randomizing device (e.g., of a roulette wheel 150) and a virtual croupier screen 160. In some embodiments, the virtual croupier screen 160 displays a video simulation of a croupier (e.g., virtual croupier 125) for interaction with the video device 158, such as through processing one or more stored programs stored in a memory 195 to implement the rules of game play at the video device 158. The virtual croupier screen 160 may be carried by a generally vertically extending cabinet 162 of the video device 158. The randomizing device screen 164 is configured to display the randomizing device outcome. A randomizing device (also referred to as a “randomizer”) includes a device that generates and displays (e.g., via indicia) the randomness element of a game of chance. A randomizing device may include, but is not limited to, one or more of a die or set of dice, a playing card or set of playing cards, a playing tile or set of tiles, a roulette wheel, a numbered ball drawn from a container, a spinning top, etc. The randomizing device functions as a random number generator that can produce random outcomes. Physical randomizing devices are often used for casino table games. Electronic randomizing devices operate according to randomizing algorithms that match or mimic the randomization characteristics of a physical version of the randomizing device. In one example, the gaming system 100 is electronic game system having a random number generator (e.g., run by control processor 197 or game controller 210) based on the randomizing device for the actively played wagering game. During an active bet cycle of the wagering game (e.g., of the roulette game), the player may select (via one of the player terminals 114A through 114E) one or more betting patterns for the wagering game (e.g., for roulette) and the player can also buy-in to an associated bingo game session. After the player selects the betting pattern(s) for the wagering game, the randomizing device produces a random outcome (having a particular pattern or configuration of the random device elements, referred to herein as an “outcome pattern”) and a bingo game manager (e.g., bingo game manager 310) provides a set of bingo cards, specifically for the player, which an active player terminal displays. The set of bingo cards may include one or more constituent bingo cards (e.g., one or more instances of the 5×5 bingo card). Herein, each constituent card included in a set of bingo cards may be referred to as a bingo card or a player card. The bingo game controller highlights the interim prize pattern on the set of bingo cards. In response to the randomizing device generating the game outcome pattern, the bingo game manager provides one or more interim bingo ball draw derived from that outcome pattern. The gaming system 100 (e.g., via an active terminal) marks spaces or entries on the set of bingo cards that correspond to the game outcome pattern (via an interim draw mapping and/or prize pattern index, e.g., see FIG. 7 for more detail).

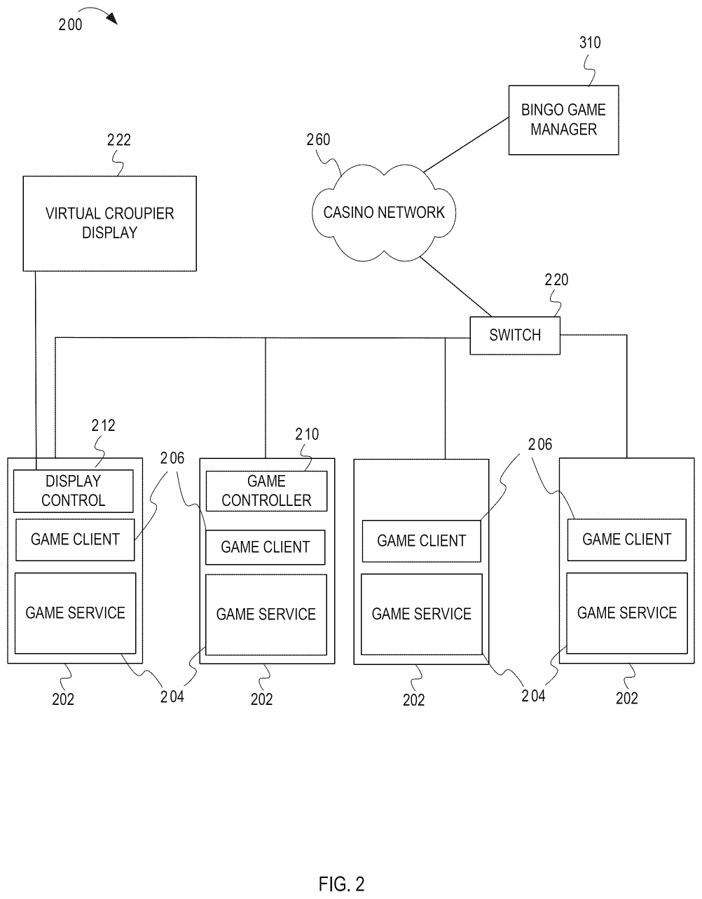

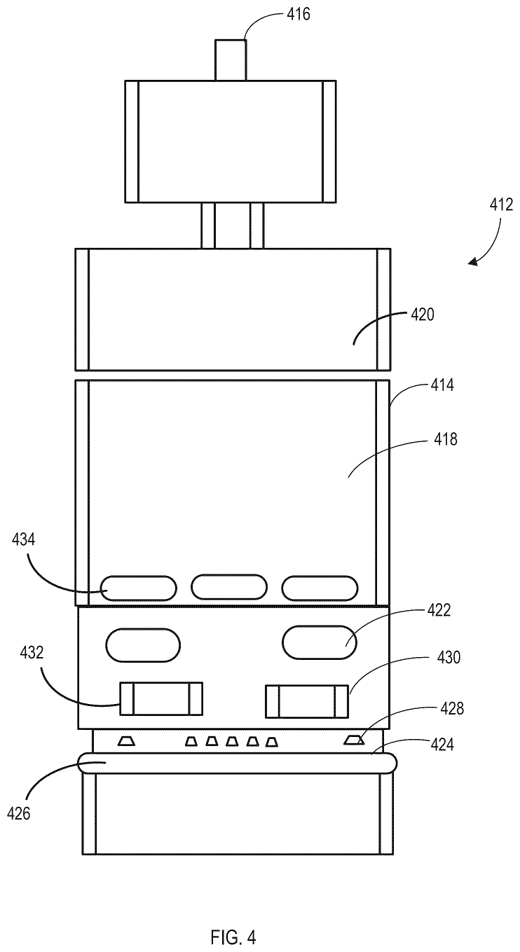

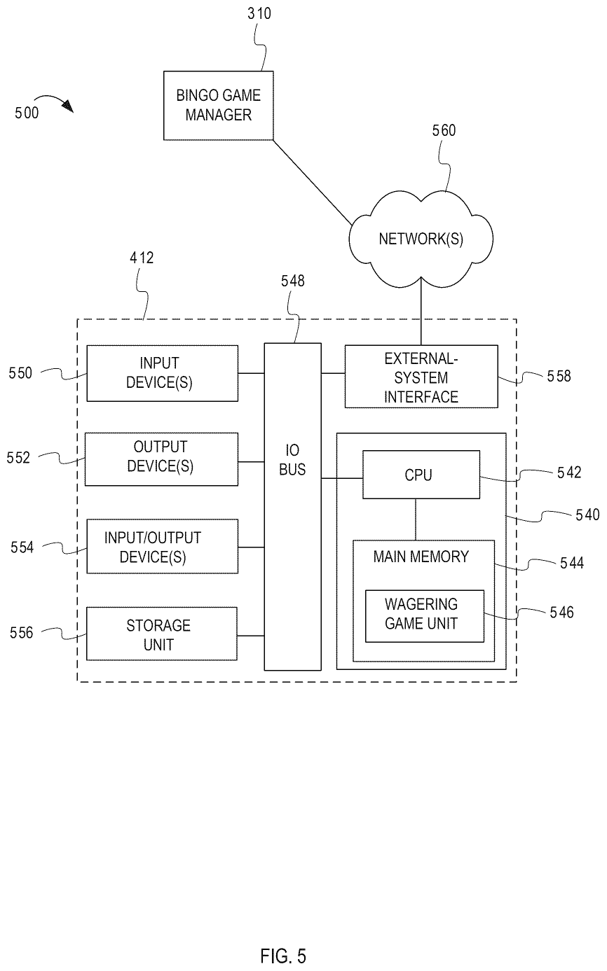

Each of the player terminals 114A through 114E includes a respective player interface area 132A through 132E that is configured for wagering and game play interactions with the video device 158 and/or virtual croupier 125. The player interface area 132A through 132E can present (depending on a display mode) either one of a user interface (e.g., see user interface 412 in FIG. 4) or a display (e.g., see display 403 in FIG. 4). Furthermore, in some embodiments, all or more of the portion (and/or content) of the display can be presented via the video device 158. Accordingly, game play may be accommodated without involving a physical roulette wheel, physical chips, and/or live personnel. The action may instead be simulated by control processor 197 interacting with and controlling the video device 158. The control processor 197 may be located internally within, or otherwise proximate to, the video device 158, such as in one of the player terminals 114A through 114E. The control processor 197 may be programmed to implement the rules of game play at the video device 158. As such, in some embodiments, the control processor 197 interacts and communicates with display/input interfaces and data entry inputs for each player interface area 132A through 132E of the respective player terminals 114A through 114E. Other embodiments of gaming systems and gaming devices may include a control processor that may be similarly adapted to the specific configuration of its associated device. In some examples herein, the control processor 197 is referred to as a game controller (e.g., game controller 210). Furthermore, in some examples, the player terminals 114A through 114E can vary in number or location. For example, any of the player terminals 114A through 114E may be any one of the player terminals 202 described in FIG. 2, or any of the player terminals 541, 542, or 543 described in FIG. 4 and FIG. 5.

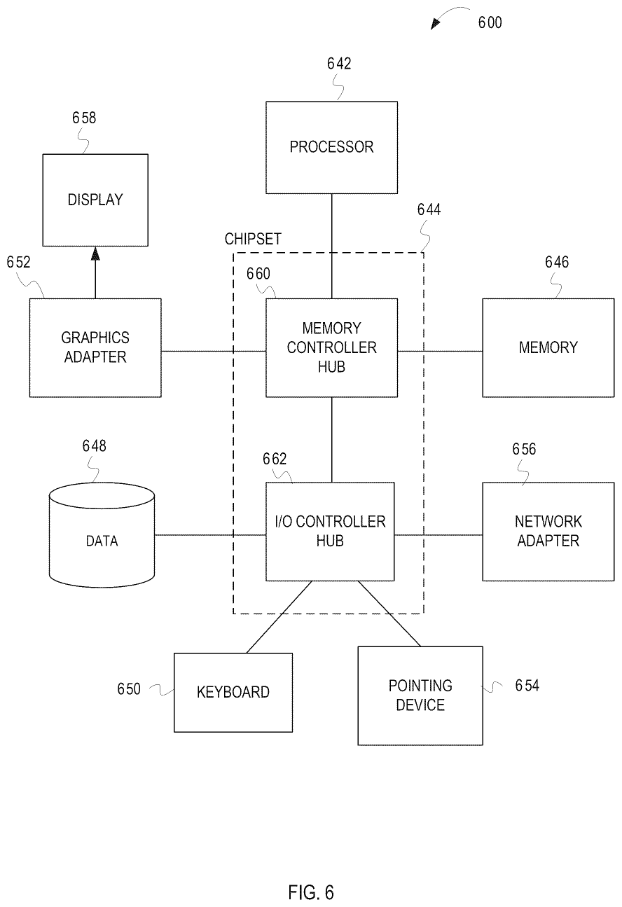

Still referring to FIG. 1, a communication device 199 may be included and operably coupled to the control processor 197 such that information related to operation of the gaming system 100, information related to the game play, or combinations thereof may be communicated between the gaming system 100 and other devices (not shown) through a suitable communication media, such, as, for example, wired networks, Wi-Fi networks, and cellular communication networks. In some embodiments, the communication device 199 is, or is associated with, switch 220 of FIG. 2, casino network 260, external system interface 558 of FIG. 5, network(s) 560 and/or network adapter 656 of FIG. 6.

Referring still to FIG. 1, the video device 158 may further include one or more banners 155 configured to communicate rules of play and/or the like, which may be located along one or more walls of the cabinet 162 or otherwise incorporated into the video device 158. The video device 158 may further include additional decorative lights (e.g., emotive lighting 170) and speakers (not shown). In some embodiments, the processor animates highlight effects with the decorative lights. For instance, the processor can select a color for the decorative lights that matches (e.g., an attribute or characteristic of) a highlight effect.

Further detail of an example of a table and/or gaming system and player displays is disclosed in U.S. patent application Ser. No. 10/764,995, filed Jan. 26, 2004, published as United States Patent Application Publication No. 2005/0164762 on Jul. 28, 2005, now U.S. Pat. No. 8,272,958, issued Sep. 25, 2012, and titled “AUTOMATED MULTIPLAYER GAME TABLE WITH UNIQUE IMAGE FEED OF DEALER,” the disclosure of each of which application and patent is incorporated herein in its entirety by this reference. Although an embodiment is described showing individual discrete player terminals, in some embodiments, the entire playing surface (e.g., player interface areas 132A through 132E, randomizing device screen 164, etc.) may be an electronic display that is logically partitioned to permit game play from a plurality of players for receiving inputs from, and displaying game information to, the players, the dealer, or both.

FIG. 2 is a schematic block diagram of a gaming system architecture (“architecture 200”) according to at least some aspects of the disclosed concepts. The architecture 200 includes a plurality of player terminals 202 communicatively coupled via a network communication device (e.g., switch 220) to a virtual croupier display 222. The virtual croupier display 222 presents instructions from a virtual croupier for a group roulette game (e.g., as presented by video device 158 in FIG. 1). The virtual croupier display 222 is controlled by a display control 212 associated with one of the player terminals 202. The display control 212 is configured to present a roulette wheel (e.g., the display control 212 animates the roulette wheel 150 (see FIG. 1) or roulette wheel 550 (see FIG. 5)) via the virtual croupier display 222. Furthermore, a game engine (also referred to as game controller 210), is associated with a different one of the player terminals 202. The game controller 210 executes roulette-outcome logic, resets won progressive values, and contains a random number generator (RNG) to (a) determine a final resting position for a roulette ball, (b) randomly select and provide multiplier levels to active player terminals, (c) randomly select and provide layout values for some multiplier levels, (d) randomly select and provide unique layout values for progressive-related multiplier level, (c) etc.

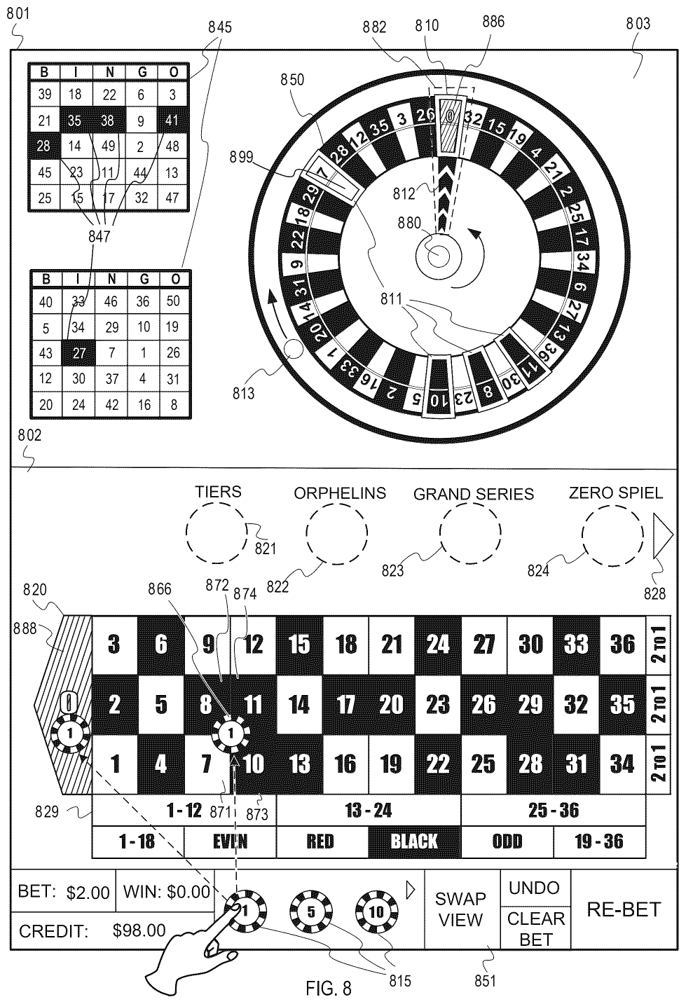

Each of the player terminals 202 includes a game client 206 that subscribes to a game service 204 associated with the roulette game. Each of the game clients 206 is configured to present game content (e.g., game assets for betting layouts, roulette wheels, highlight effects, etc.). In some embodiments, the game clients 206 are configured to present the game content and highlight effects via player interface areas 132A through 132E (shown in FIG. 1). In some embodiments, the game clients 206 are configured to present the game content via user interfaces (e.g., see user interface 802 in FIG. 8). Furthermore, in some embodiments, the game service 204 is associated with the game controller 210 and/or a game server.

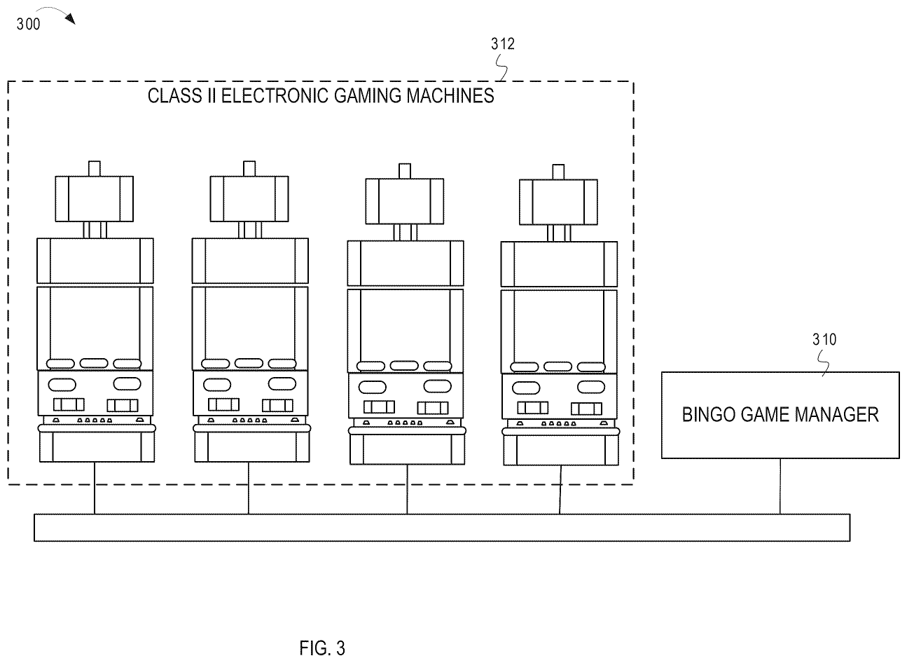

Referring to FIG. 3, a bingo gaming system includes a bingo game manager 310 (e.g., a bingo game server) that conducts a multi-player bingo game played via a plurality of Class II electronic gaming machines 312. The bingo game manager 310 is a centralized computer system whose job is to manage one or more bingo games at a Class II gaming site/establishment or across multiple Class II gaming sites. This computer system includes, in various aspects, one or more servers, controllers, communications hardware, or a variety of other interfaced systems or components, in any combination. The bingo game manager 310 generates virtual/electronic bingo cards such that duplicates of the same card are not “sold” for any common ball draw. In other words, the same bingo card does not appear twice in any bingo game, where a bingo game is defined by the balls being drawn. The bingo game manager 310 also manages a random drawing of virtual/electronic bingo balls when two or more players start a bingo game. To perform the random drawing, the bingo game manager 310 executes random-number-generator (RNG) programming to generate one or more pseudo-random numbers. The RNG cannot be carried out manually by a human and is integral to operating the bingo game. The bingo game manager 310 delivers the virtual balls and virtual bingo cards to gaming machines 312 that join the game. Any of the gaming machines 312 that is actively being played evaluates the delivered virtual balls and the virtual bingo card purchased at the machine to determine if a player achieves a bingo game pattern such as a game ending pattern or an interim prize pattern. If the player achieves a game ending pattern, then the bingo game ends and the player is awarded a prize. If the player achieves an interim prize pattern (before a game ending pattern occurs), then the player is awarded an interim prize. Any of the gaming machines 312 can further present an entertainment outcome on its display(s) via entertaining animations.

Referring to FIG. 4, a gaming machine 412 may be any type of gaming terminal or machine (e.g., any of the gaming machines 312, any of the player terminals 114A-114E, etc.) and may have varying structures and methods of operation. For example, in some aspects, the gaming machine 412 is an electronic gaming terminal configured to play a Class II bingo game and present a bingo score through some form of “entertainment” mechanism that may or may not be related to bingo. The entertainment mechanism may, for example, be in the form of a non-bingo game such as slots, keno, poker, blackjack, roulette, craps, etc. In the illustrated embodiment, the entertainment mechanism is in the form of a video slot game including a plurality of simulated symbol-bearing reels that are rotated and stopped to land symbols on the reels in a symbol array or matrix in visual association with win lines or ways. The pay table for the slot game may, for example, include “line pays,” “scatter pays,” and bonus triggers that trigger bonus games. Line pays occur when a predetermined type and number of symbols appear along an activated line, typically in a particular order such as left to right, right to left, top to bottom, bottom to top, etc. Scatter pays occur when a predetermined type and number of symbols appear anywhere in the displayed array without regard to position or lines. The gaming machine 412 may take any suitable structure, such as a floor-standing, stationary model as shown, bartop model, workstation-type console model, etc. The gaming machine 412 may be primarily dedicated for use in playing bingo games with attendant entertainment mechanisms.

The gaming machine 412 comprises a gaming cabinet 414 that securely houses various input devices, output devices, input/output devices, internal electronic/electromechanical components, and wiring. The cabinet 414 includes exterior walls, interior walls and shelves for mounting the internal components and managing the wiring, and one or more front doors that are locked and require a physical or electronic key to gain access to the interior compartment of the cabinet 414 behind the locked door. A notification mechanism 416, such as a candle or tower light, is mounted to the top of the cabinet 14 and flashes to alert an attendant that change is needed, a hand pay is requested, or there is a potential problem with the gaming machine 412.

Input devices, output devices, and input/output devices are disposed on, and securely coupled to, the cabinet 414. By way of example, the output devices include a primary display 418, a secondary display 420, and one or more audio speakers 422. The primary display 418 or the secondary display 420 may be a mechanical-reel display device, a video display device, or a combination thereof in which a transmissive video display is disposed in front of the mechanical-reel display to portray a video image superimposed upon the mechanical-reel display. The displays variously display information associated with bingo games, entertainment mechanisms, progressives, advertisements, services, premium entertainment, text messaging, emails, alerts, announcements, broadcast information, subscription information, etc. appropriate to the particular mode(s) of operation of the gaming machine 412. The gaming machine 412 includes an input ledge or deck 424 disposed below the primary display 418 and extending forwardly towards a player positioned in front of the machine. The input deck 424 bears a narrow video button panel 426 and one or more electromechanical push buttons 428 adjacent to the panel 426. The video button panel 426 may be an iDeck™ panel offered on gaming machines manufactured by the LNW Gaming, Inc. The primary display 418, the secondary display 420, and the video button panel 426 may be outfitted with respective touch screens to enable a player to make inputs via touch keys depicted on the underlying displays. The gaming machine 412 includes a bill/ticket acceptor 430, a ticket dispenser 432, and player-accessible ports (e.g., audio output jack for headphones, video headset jack, USB port, wireless transmitter/receiver, etc.) disposed below the primary display 418 and above the input deck 424. It should be understood that numerous other peripheral devices and other elements exist and are readily utilizable in any number of combinations to create various forms of a gaming machine 412 in accord with the present concepts.

The player input devices, such as the touch screens (in front of the various displays), the push-button(s) 428, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” push-button or soft touch key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 412 includes one or more value input/payment devices and value output/payout devices. In order to deposit cash or credits onto the gaming machine 412, the value input devices are configured to detect a physical item associated with a monetary value that establishes a credit balance on a credit meter such as the “credit” meter 434. The physical item may, for example, be currency bills, coins, tickets, vouchers, coupons, cards, and/or computer-readable storage mediums. The deposited cash or credits are used to fund wagers placed on the bingo game played via the gaming machine 412. Examples of value input devices include, but are not limited to, a coin acceptor, the bill/ticket acceptor 430, a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the “credit” meter 434, the value output devices are used to dispense cash or credits from the gaming machine 412. The credits may be exchanged for cash at, for example, a cashier or redemption station. Examples of value output devices include, but are not limited to, a coin hopper for dispensing coins or tokens, a bill dispenser, a card reader/writer, the ticket dispenser 432 for printing tickets redeemable for cash or credits, a wireless communication interface for transmitting cash or credit data to a nearby mobile device, and a network interface for depositing cash or credits to a remote account via an electronic funds transfer.

Referring to FIG. 5, there is shown a gaming system 500 including the architecture of an electronic gaming machine (e.g., gaming machine 412). The gaming machine 412 includes game-logic circuitry 540 securely housed within a locked box inside the gaming cabinet 414 (see FIG. 4). The game-logic circuitry 540 includes a central processing unit (CPU) 542 connected to a main memory 544 that comprises one or more memory devices. The CPU 542 includes any suitable processor(s), such as those made by Intel and AMD. By way of example, the CPU 542 includes a plurality of microprocessors including a master processor, a slave processor, and a secondary or parallel processor. Game-logic circuitry 540, as used herein, comprises any combination of hardware, software, or firmware disposed in or outside of the gaming machine 412 that is configured to communicate with or control the transfer of data between the gaming machine 412 and a bus, another computer, processor, device, service, or network. The game-logic circuitry 540, and more specifically the CPU 542, comprises one or more controllers or processors and such one or more controllers or processors need not be disposed proximal to one another and may be located in different devices or in different locations. The game-logic circuitry 540, and more specifically the main memory 544, comprises one or more memory devices which need not be disposed proximal to one another and may be located in different devices or in different locations. The game-logic circuitry 540 and bingo game manager 310 are operable to execute the various gaming methods and other processes disclosed herein.

The game-logic circuitry 540 is also connected to an input/output (I/O) bus 548, which can include any suitable bus technologies, such as an AGTL+ frontside bus and a PCI backside bus. The I/O bus 548 is connected to various input devices 550, output devices 552, and input/output devices 554 such as those discussed above in connection with FIG. 4. The I/O bus 548 is also connected to a storage unit 556 and an external-system interface 558, which is connected to the bingo game manager 310 via network(s) 560.

The gaming machine 412 may include additional peripheral devices or more than one of each component shown. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), non-volatile random-access memory (NVRAM), magnetic-disk storage media, optical storage media, flash memory, etc.

The bingo game manager 310 and the gaming machine 412 constitute gaming equipment that meets the hardware and software requirements for fairness, security, and predictability as established by a gaming control board or commission (e.g., National Indian Gaming Commission) charged with regulating Class II games. Prior to commercial deployment, the gaming equipment must satisfy minimum technical standards and obtain regulatory approval from the applicable gaming control board or commission. As can be seen from the description herein, the gaming equipment may be implemented with hardware and software architectures, circuitry, and other special features that differentiate them from general-purpose computers (e.g., desktop PCs, laptops, and tablets). Furthermore, the gaming equipment stores programming and data that is verified by a trusted authentication program(s) prior to game execution. The authentication program generates a live authentication code (e.g., digital signature or hash) from memory contents and compares it to a trusted code. If the codes match, authentication is deemed a success and the game is permitted to execute. If, however, the codes do not match, authentication is deemed a failure that must be corrected prior to game execution. Without this predictable and repeatable authentication, the gaming equipment is not allowed to perform or execute the programming in a regulatory-approved manner and is therefore unacceptable for commercial use. In other words, through the use of the authentication program, the gaming equipment facilitates operation of the game in a way that a person making manual calculations or computations could not.

Referring to FIG. 4, the bingo game manager 310 manages a bingo game utilizing virtual bingo cards such as any of the bingo cards illustrated in the set of bingo cards 845, the set of bingo cards 1645, or the set of bingo cards 2045. For example, in 75 ball bingo, the bingo card has a traditional arrangement of 25 numbers in a 5×5 grid with no free space. For each bingo card generated by the bingo game manager 310, each of the 25 card “spots” or “spaces” is randomly assigned a numerical value between 1 and 75 (inclusive). Any number may appear in any location on the card, and no single number may appear more than once on the card. In any bingo game, no two bingo cards are the same. When a player at a gaming terminal (e.g., at gaming machine 412) purchases a bingo card and joins a bingo game, the bingo card may be displayed on the video button panel 26, the primary display 18, or the secondary display 20 of the gaming machine 412. In another embodiment, the bingo card has a different arrangement and/or different number of spots, and the bingo game uses more or less than 75 balls and/or designations (e.g., A, B, C, D, etc.) other than numbers on the balls.

The commencement of a bingo game occurs when two or more players have purchased respective bingo cards within some common time frame (typically less than a second) at one of the “buy-in” options provided by their respective gaming machines 12. Therefore, when starting a bingo game, the bingo game manager 310 waits for two or more players to begin game play within the common time frame. The bingo card purchase is an indication that the player wishes to play a bingo game. During purchase of the bingo card, the bingo game manager 310 ensures that no duplicate cards are sold for any common draw. The bingo game manager 310 then randomly shuffles the numbers between 1 and 75 (inclusive) and simultaneously delivers those numbers in the shuffled order in one message to each player's gaming machine. This act is referred to as the bingo game “ball draw.”

The bingo game is won by the first player covering a previously designated arrangement of numbers or designations on their bingo card (or set of bingo cards). This arrangement is referred to as the “game ending pattern.” The bingo game uses a single (one and only one) game ending pattern. In addition to this game ending pattern, the bingo game manager 310 defines a condition in which the bingo game is won and concluded when the game ending pattern is achieved within the first ‘N’ balls of the 75 balls received.

If the bingo game manager 310 is hosting a bingo game in which no player achieved the game ending pattern, then new players, including players that may have already participated in the bingo game, may join the bingo game that is in progress by buying a new set of bingo cards at their gaming machine 412. The bingo game manager 310 then delivers the 75 balls for the bingo game to those new players and performs the game ending pattern check. If no game ending pattern has been achieved, the bingo game remains “alive” and allows new players to join.

National Indian Gaming Commission rules allow for interim prizes and simultaneous winners. Accordingly, in addition to achieving the game ending pattern within the first ‘N’ balls as described above, interim prizes are available to players if they achieve an interim prize pattern (e.g., within a given ‘M’ balls of the 75 balls received). The bingo game uses interim prize patterns that are customized to the player's selection of selectable bet patterns.

Each player purchasing a bingo card at a gaming machine 412 and receiving the 75 bingo balls has their card “evaluated” automatically by the gaming machine 412 on which they are playing, after all 75 balls have been received. Each player within the bingo game achieving the interim prize pattern conditions applicable to their buy-in option and their selection of a bet pattern is awarded a prize which is determined by a variety of factors, including, but not limited to, a type of bet made, a buy-in option, an interim prize pattern, an interim prize score, etc. In some embodiments, an interim prize score has a theoretically known probability that can be mapped to prizes/outcomes from the entertainment mechanism as described in U.S. Patent Application Publication No. 20220292912 for U.S. patent application Ser. No. 17/824,964, filed May 26, 2022, which Ser. No. 17/824,964 application is incorporated by reference herein in its entirety.

Furthermore, in one embodiment, the bingo game manager 310 delivers all bingo balls for a bingo game to each player's gaming machine 412 in a single message. Thus, the bingo game manager 310 is free to handle player daubing in an asynchronous manner.

FIG. 6 is a block diagram of a computer system 600 according to one or more embodiments. In one embodiment, the computer system 600 can be used for acting as at least some portion of any system described herein, such as the gaming system 100 (see FIG. 1) or the gaming system 300 (see FIG. 3). The computer system 600 includes at least one processor 642 coupled to a chipset 644, as indicated in dashed lines. Also coupled to the chipset 644 are memory 646, a storage device 648, a keyboard 650, a graphics adapter 652, a pointing device 654, and a network adapter 656. A display 658 is coupled to the graphics adapter 652. In one embodiment, the functionality of the chipset 644 is provided by a memory controller hub 660 and an I/O controller hub 662. In another embodiment, the memory 646 is coupled directly to the processor 642 instead of to the chipset 644.

The storage device 648 is any non-transitory computer-readable storage medium, such as a hard drive, a compact disc read-only memory (CD-ROM), a DVD, or a solid-state memory device (e.g., a flash drive). The memory 646 holds instructions and data used by the processor 642. The pointing device 654 may be a mouse, a track pad, a track ball, or another type of pointing device, and it is used in combination with the keyboard 650 to input data into the computer system 600. The graphics adapter 652 displays images and other information on the display 658. The network adapter 656 couples the computer system 600 to a local or wide area network.

As is known in the art, the computer system 600 can have different and/or other components than those shown in FIG. 6. In addition, the computer system 600 can lack certain illustrated components. In one embodiment, the computer system 600 acting as the gaming system 100 (FIG. 1) lacks the keyboard 650, pointing device 654, graphics adapter 652, and/or display 658. Moreover, the storage device 648 can be local and/or remote from the computer system 600 (such as embodied within a storage area network (SAN)). Moreover, other input devices, such as, for example, touch screens may be included.

The network adapter 656 (may also be referred to herein as a communication device) may include one or more devices for communicating using one or more of the communication media and protocols discussed above with respect to FIG. 1, FIG. 3, etc.

In addition, some or all of the components of this general computer system 600 of FIG. 6 may be used as part of the processor and memory discussed above with respect to the systems or devices described in FIG. 1, FIG. 2, FIG. 3, FIG. 4, or FIG. 5.

The gaming system 100 (FIG. 1) and/or the gaming system 300 (FIG. 3) may comprise several such computer systems 600. The gaming system 100 may include load balancers, firewalls, and various other components for assisting the gaming system 100 to provide services to a variety of user devices.

The computer system 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 648, loaded into the memory 646, and executed by the processor 642.

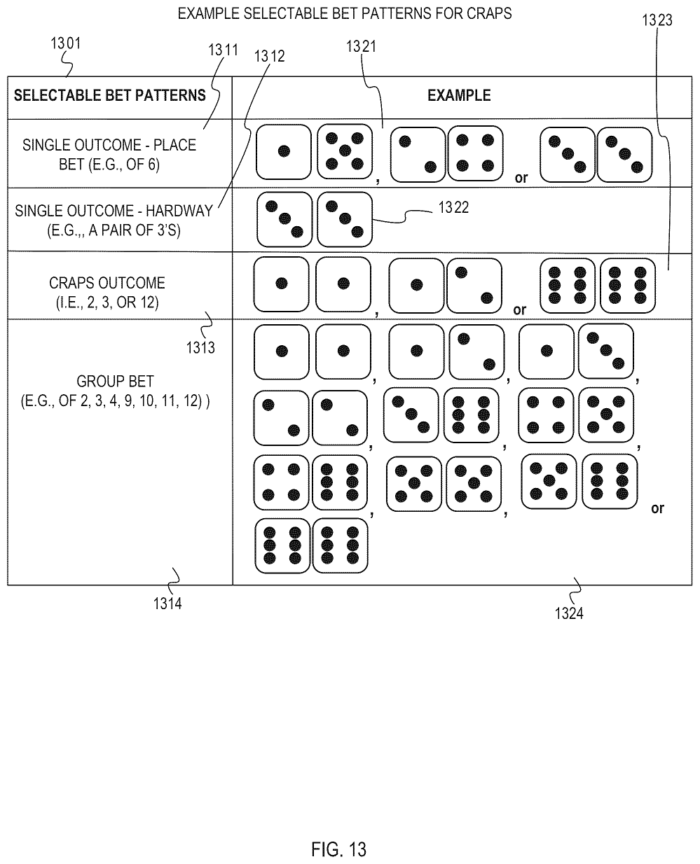

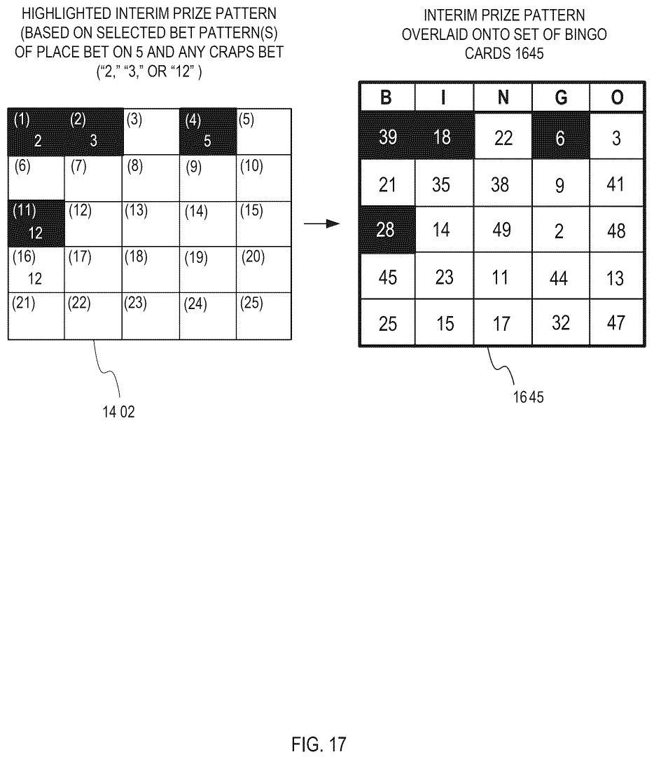

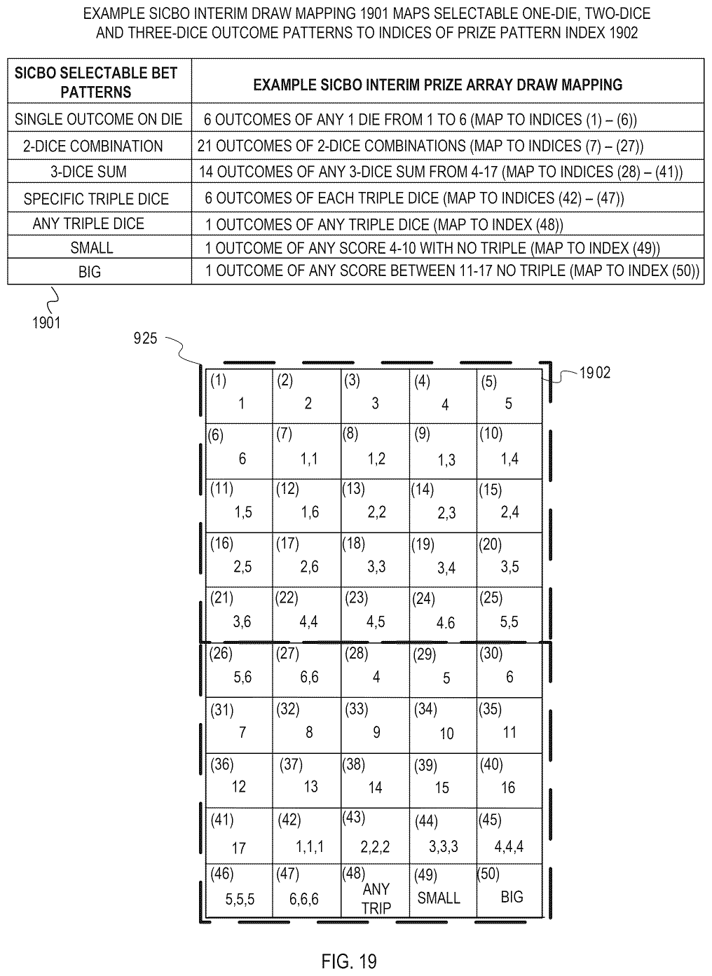

FIG. 7 is a flowchart of a flow (700) for controlling interim bingo game features according to at least some aspects of the disclosed concepts. 8-12, FIG. 13-18, FIG. 19-22 are diagrams of controlling one or more interim bingo features according to at least some aspects of the disclosed concepts. FIG. 8-12, FIG. 13-18, and FIG. 19-22 include different examples that illustrate the flow 700 and will be referred to concurrently with the description of the flow 700. It should be noted that while some embodiments disclosed mention one or more devices that perform an action, the processor that performs the action may one of one or more processors that are available by a gaming system and/or distributed across a gaming network.

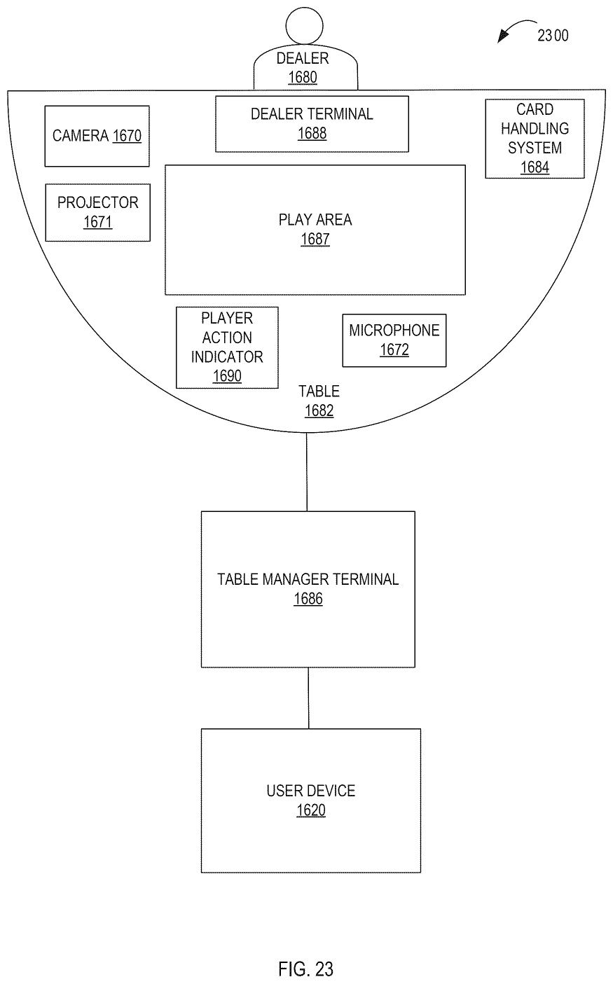

Referring to FIG. 7, the flow 700 starts at processing block 702, where a processor detects selection of a bet pattern for a wagering game. The processor can be associated with any one or more of various types of gaming systems. For example, the processor can be associated with the bingo game manager 310. In another example, the processor can be associated with a table-game system having sensors (e.g., image sensors, distance sensors, 3D tracking sensors, motion sensors, etc.) or other devices and/or mechanisms that use computer vision, machine learning models, etc. to detect user activity, bet placement actions, betting devices (e.g., chip placement on betting spots), play actions (e.g., croupier actions to open or close betting, player and/or dealer activation or use of randomizing devices), side-betting, etc. (e.g., see FIG. 23). In another example, the processor is associated with a gaming machine associated with bingo, such as at gaming machine 412. In yet another example, the processor is associated with an active gaming terminal such as one of player terminals 114A through 114E (e.g., as shown in FIG. 5). In one example, an active gaming terminal detects and notifies a game controller of placement of one or more game bets made via betting layouts presented via the terminal. The gaming terminal is associated with a gaming system(s) that can provide any of a number of games, such as poker, roulette, Craps, etc. In one example, the gaming system is an electronic roulette system. The betting layouts are presented at each player terminal, and each betting layout has equivalent betting layout values. FIG. 8 illustrates an example of a player terminal 801 used for roulette. The player terminal 801 includes a display 803 and a user interface 802. The display 803 presents a randomizing device (e.g., roulette wheel 850 and ball 813) used to present play of a roulette game. The display 803 also presents a set of bingo cards 845 having a highlighted interim prize pattern 847. On the user interface 802 are controls, settings, objects, etc. that a player interacts with during a game of roulette and/or for use in the associated bingo game. The user interface 802 further includes a betting layout 820 for placement of one or more bets (i.e., for selection of one or more bet patterns available for roulette). In one example, the user interface 802 includes a plurality of different virtual tokens of differing denomination values (e.g., a token worth $1, a token worth $10, etc.). While only some denomination values are shown, other denomination values may be included (e.g., 15, 20, 25, 50, 100, etc.). In some embodiments, the other virtual tokens may be accessible via a user-interface object (e.g., via scroll control). In other embodiments, the ranges of denomination values may be automatically set based on other game factors, such as for a betting level or tier associated with multiplier ranges. A more detailed description of how betting levels or tiers are associated with multiplier ranges can be found in the Ser. No. 17/948,755 application and/or the Ser. No. 17/948,633 application referenced previously.

A player can drag one or more of the virtual tokens onto one or more positions (betting spots) on the betting layout 820 associated with one or more types of bets (associated with one or more selectable betting patterns associated with the game of roulette). When the player releases the drag-and-drop feature (e.g., when the player lifts their finger off of the user interface 820), the bet is placed. Once the croupier calls an end to betting, because the virtual token is in a betting spot, the bet is accepted for a bet type associated with the betting spot. The player terminal then locks the position of the virtual token in place onto the betting layout 820.

The betting layout 820 is configured for placement of various types of bets, such as a single-value bet type or a multi-value bet type. A single-value bet type involves a bet on an individual (single) value associated with the betting layout 820, such as the layout value “0” (at betting spot 888) on which a player has made a “straight up” bet. A multi-value bet type involves a bet on a group of values associated with the roulette wheel. Examples of multi-value bet types can be found in the Ser. No. 17/948,755 application and/or the Ser. No. 17/948,633 application referenced previously. For example, a multi-value bet type can include an outside bet (e.g., a bet from outside bet section 829). The outside bet section 829 includes betting spots for various types of multi-value bets, such as red/black bet, an odd/even bet, a high/low bet, a column bet, a dozens bet, etc. A multi-value bet type can also include an inside bet other than a straight-up bet, such as a split bet, a street bet, a corner bet, a line bet, a five-number bet, a basket bet, a snake bet, etc.). Corner bets, for example, are placed on a corner point that connects multiple betting spots. The position of placement of the corner bet thus straddles the adjoining number values on the betting layout 820 and indicates a multi-value bet on the group of number values that the virtual token straddles. Hence, the betting spot for a corner bet includes the intersecting point on which the virtual token is placed. For example, as shown in FIG. 8, a virtual token can be placed as a corner bet over the corner point at the adjoining bet spots 871, 872, 873, and 874 associated, respectively, with the layout values for “7,” “8,” “10,” and “11.” Furthermore, a multi-value type bet can also include “call” type bets, such as a Voisins du Zero bet, a Jeu Zero bet, a Tiers du Cylindre bet (or “Tiers” bet), an Orphelins bet, a Neighbors bet, a Grand Series bet, a Zero Spiel bet, etc. The betting layout can also include additional betting spots (e.g., betting spots 821, 822, 823, and 824) which are related to the call type bets. The betting layout 1320 can include additional betting spots for additional types of call bets or other types of bets, such as a Final Bet, a Complete Bet, an Imprisonment Bet, etc. The additional types of bets can be accessed via a user interface object, such as via a selection of a scroll control 828, or via a selection of a “Swap View” button 851.

When the bets are placed (i.e., when the virtual tokens are positioned onto the betting spots 888 and/or the corner of adjoining betting spots 871, 872, 873, and 874), one or more highlight effects (e.g., 810, 811, or 812) can appear on one or more portions of a roulette wheel 850 (e.g., on various segments) such as highlight effect 810 around pocket 886 or the highlight effect 812 associated with segment 882, which one or more portions correspond to the selected bet-upon values from the betting layout 820. The processor selects and/or animates different highlight effects for different bet types. For example, the processor utilizes different highlight effects for single-value bet types versus multi-value bet types. Examples of highlighting single-value bet types and multi-value bet types can be found in the Ser. No. 17/948,755 application and/or the Ser. No. 17/948,633 application referenced previously.

In addition, the display 803 presents, based on the bets placed (e.g., based on the selected betting patterns made via the betting layout 820), a set of bingo cards 845 having random numbers placed within game spaces of a game grid. As shown in FIG. 8, the game grid for the set of bingo cards 834 is a 5×5 array structure used for 75-ball bingo, however other bingo game types or structures can be used, such as a 9×3 grid for 90-ball bingo. In one embodiment, the set of bingo cards 845 displays highlighted spaces (also referred to herein as highlighted entries) related to a bingo game ending pattern and for an interim prize pattern. In one example, the bingo game is won and concluded when the game ending pattern is achieved within a first number (“N”) of the 75 balls received. The value of ‘N’ is configurable. Once a value of ‘N’ is selected, it applies to all players in a bingo game and does not change once a bingo game has started. The game ending pattern and the value of ‘N’ are made known to the player prior to the player's participation in any bingo game. In FIG. 8, a bingo game ending pattern is not illustrated so as to not obscure a view of the interim prize pattern 847. The interim prize pattern 847 is collectively the displayed highlighted spaces that are related to the interim prize. Interim prizes are available to players if they achieve a ball draw that matches at least one of the highlighted space on the set of bingo cards 845. Regarding the selectable bet patterns for the wagering game (e.g., regarding the betting options available for selection via the betting layout 820), in at least one embodiment the selectable bet patterns represent a set of predefined patterns of possible combinations of outcomes (also referred to as “outcome patterns”) for a randomizing device of the wagering game. For any given randomizing device, all possible outcomes of the device are known. Outcomes are based on the physical properties of the device and any associated rules of game play. Each outcome pattern may or may not be unique. There are ‘X’ individual outcomes for a randomizing device. For example, a single-zero roulette wheel has X=37 individual outcomes (numbers 0 and 1-36). A double-zero roulette wheel, on the other hand, has X=38 individual outcomes (numbers 0, 00 and 1-36). In another example, the dice game craps utilizes outcome patterns of two dice and has a total of X=36 possible outcomes. Some outcomes are not unique. In another example, the dice game Sic bo (or “sicbo”) utilizes the outcome patterns of up to three dice and has a total of X=216 possible outcomes. Some outcomes are not unique. Given that some outcomes are not unique, the set of predefined patterns that are selectable by a player for betting in the game includes only unique combinations of the total possible outcomes. Furthermore, the set of predefined patterns that are correlated to a bingo game depends on the particular rules of the wagering game.

In one instance, the selectable bet patterns represent all possible combinations of outcome patterns of a physical randomizing device. Each pattern is unique and can be from 1 to X. The number of possible combinations will be C=2\hat{ }X−1. For example, for roulette, the possible ball pockets on the wheel define all available outcomes related to the wheel. One or more of these patterns may be selected by the player during game play. Thus, any selectable betting patterns for an associated bingo game can be related to only the wheel number outcomes (e.g., selectable betting patterns related to pocket color may be excluded). The selectable betting patterns related to the wheel number outcomes are therefore used for mapping to specific interim prize spaces 847 on a bingo card (e.g., see FIG. 8-12).

Regarding craps and sicbo, the possible combination of unique dice outcomes based upon the game rules will define the available outcomes. One or more of these patterns may be selected by the player during game play. Craps utilizes the outcome of combined face value of two dice. The craps game rules dictate that the player may be on either the combined face value of the dice (11 outcomes of 2 through 12) and on specific outcomes of pairs (four additional pairs including a pair of 2s, a pair of 3s, a pair of 4s, and a pair of 5s) this gives a total of N=15 possible outcomes. Thus, the 15 possible outcomes, according to the rules of craps, are used for correlating to specific interim prize spaces on a bingo card (e.g., see FIG. 13-18). Sicbo utilizes the outcome of up to three dice and has game rules that allow the player to bet on various combinations of the following: any individual number from 1 to 6 (6 outcomes) of one die, any combination of two dice (21 outcomes), any three dice sum from 4 to 17 (14 outcomes), each triple dice (6 outcomes), any triple dice (1 outcome), and small and big (2 outcomes) for a total of X=50 possible outcomes. Thus, the 50 possible outcomes (according to the rules of sicbo) are used for correlating to specific interim prize spaces on a bingo card (e.g., see FIG. 19-22).

Referring momentarily back to FIG. 7, the flow 700 continues at processing block 704, where a processor determines, based on a selected bet pattern and a prize pattern index, an interim prize pattern for a bingo game. In one example, determination of the interim prize pattern includes two prize pattern index determination operations. The first prize pattern index determination operation, generates/constructs, via a computer memory, a structure (patterned after a bingo card structure) for the prize pattern index (i.e., loads into computer memory a matrix/array of multiple columns and rows based on the bingo card configuration) where each of the selectable bet patterns for the roulette game correlates to at least one index value on the prize pattern array. The second prize pattern index determination operation selects, as the interim prize pattern on the array, one or more entries that map to one or more index values associated with a selected one of the selectable betting patterns (associated with a player's selected bet).

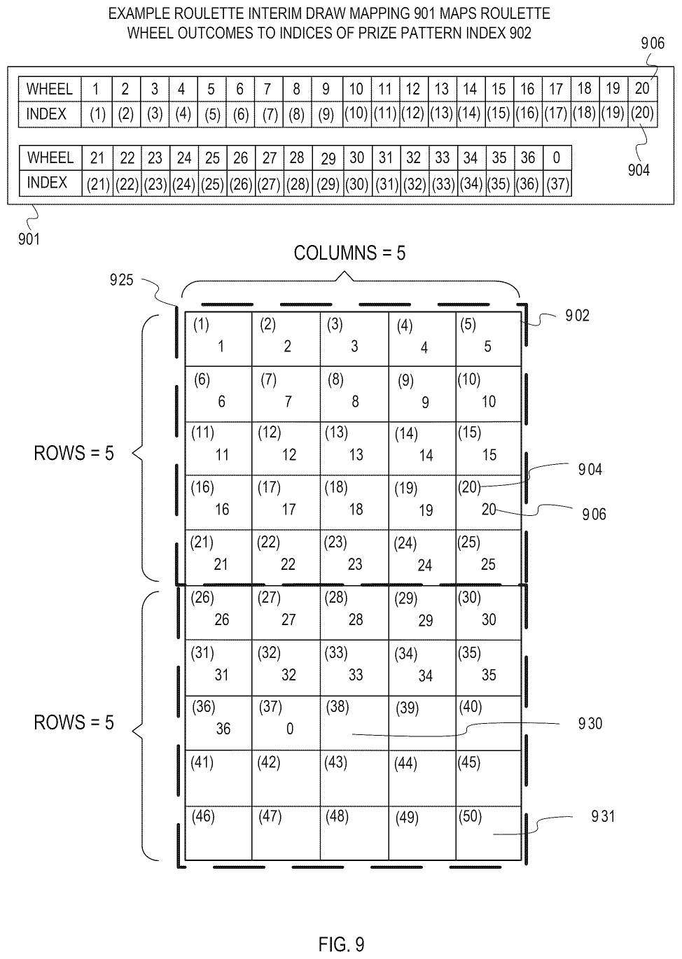

The processor performs the first prize pattern index determination operation, for example, by correlating, in the computer memory, each of the selectable bet patterns for the roulette game to an index value of a prize pattern array according to a prize pattern index/interim draw mapping (i.e., an index value on the prize pattern index is referred to herein as a “prize pattern index value”). The shape or structure of the prize pattern index is constructed in computer memory based on a bingo-card grid configuration. For example, as in FIG. 9, an example interim draw mapping 901 is shown which is used to correlate each wheel value on a roulette wheel to a unique index value of prize pattern index 902.

In one example, the configuration (e.g., shape, size, etc.) of the prize pattern index 902 (e.g., the configuration of the structure of the array/matrix for the prize pattern index 902) includes a number of columns and rows to permit each of the plurality of selectable bet patterns to be listed in at least one entry of the prize pattern index 902. In one embodiment, the number of columns of the prize pattern index 902 matches the number of columns of a bingo card (e.g., 5 columns). However, the total number of rows within the prize pattern index 902 may be less or more than a total number of rows available on a single bingo card (e.g. less or more than 5 rows). If more than 5 rows are included in the prize pattern index, then more than one bingo card will be generated/provided (e.g., see processing block 706 for more details).

In one embodiment, the interim draw mapping is a one-to-one mapping of each of the plurality of selectable bet patterns to a particular index value in the prize pattern index. For instance, for the game of roulette, the interim draw mapping 901 can include a one-to-one mapping of each possible outcome of a single randomizing device (e.g., each roulette-wheel pocket/segment value is a possible outcome) to a respective unique index value on the prize pattern index 902. For example, prize pattern index 902 is constructed as a 5×10 matrix having fifty entries with index values numbering from “(1)” through “(50).” Entries with index values from “(1)” through “(37)” are correlated to respective ones of number values on the segments of the roulette wheel (e.g., index value “(1)” is correlated to wheel value “1,” index value “(2)” is correlated to wheel value “2,” and so forth with index value “(37)” correlated to wheel value “0.”) The prize pattern index 902, therefore correlates one value to each of the first thirty-seven entries (i.e., from index value “(1)” through “(37)”). However, the prize pattern index 902 must have at least many entries as are divisible by the grid structure of the bingo card being used. For example, a template 925 of a 5×5 bingo-card grid structure is used as a template to generate the size of matrix of the prize pattern index 902. For example, the template 925 has a 5×5 structure (e.g., 5 columns by 5 rows). Therefore, in one example, the prize pattern index 902 also includes 5 columns, but must contain a number of rows that is a multiple of the number of rows set for the template 925, which is required to generate a complete set of bingo cards (e.g., see processing block 706 for more details.) In other words, because there are five rows required on each bingo card, and the number of entries required for the prize pattern index 902 is more than twenty-five (5×5), but less than fifty, the processor determines that two bingo cards will need to be generated. In other embodiments, the size of the template can vary based on the type of bingo game being played. In one embodiment, a gaming system (e.g., gaming system 100) includes an interface with a setting or control that an operator can use to select the type or version of the bingo game to be played, which in turn selects the dimensions of the template (e.g., template 925) used for the prize pattern index and/or which swaps an interim ball mapping used to map to appropriate index values via the prize pattern index.

Index values for entry 930 (corresponding to index value “(38)”) through entry 931 (corresponding to index value “(50)”) (i.e., index values (38)-(50)) do not correlate or map to any outcome from the randomizing device (e.g., do not correspond to any of the roulette wheel numbers). Meanwhile, index values (1)-(37) correlate or map (according to the interim draw mapping 901) as shown on the prize pattern index 902. In one example, wheel values “1”-“36” and “0” are associated or correlated to corresponding entry positions, via the prize pattern index 902, in ascending numerical order (e.g., starting at “1” and increasing until “36” with the wheel value “0” last). However, in other embodiments, the index values can be associated (e.g., positioned within the matrix/array of the prize pattern index 902) in a random order, with any one of the wheel values correlating on a one-to-one basis with any unique one of the index values of the prize pattern index 902. Thus, in one embodiment, the empty index values (e.g., index values that do not correlate to a selected bet pattern) can be randomly spaced through-out the prize pattern index 902.

In one embodiment, empty index values can be associated/assigned to the final space(s)/entry(ies) of the last bingo card in a set of bingo card. The uncorrelated spaces are not used for the interim prize pattern. Thus, in one embodiment, the bingo card spaces that correspond to empty prize pattern index values would have a null value, and thus a ball draw for any bingo numbers associated with the null entries would not map to (hence would not be highlighted for) any interim prize pattern, and thus would have no bearing on the interim prize being awarded.

In another embodiment, the empty index values can be assigned to enhancers for the interim prize of the bingo game. In one embodiment, the enhancers can be made available (e.g., toggled on/off) and/or have their values altered based on given betting condition of the wagering game (e.g., based on a certain type of bet pattern being selected in the wagering game). For example, the processor can toggle on an enhancement for one of the empty index values (e.g., a free space) if a higher risk bet (e.g., single-value bet type) is made as opposed to a lower risk bet (e.g., a multi-value type bet).

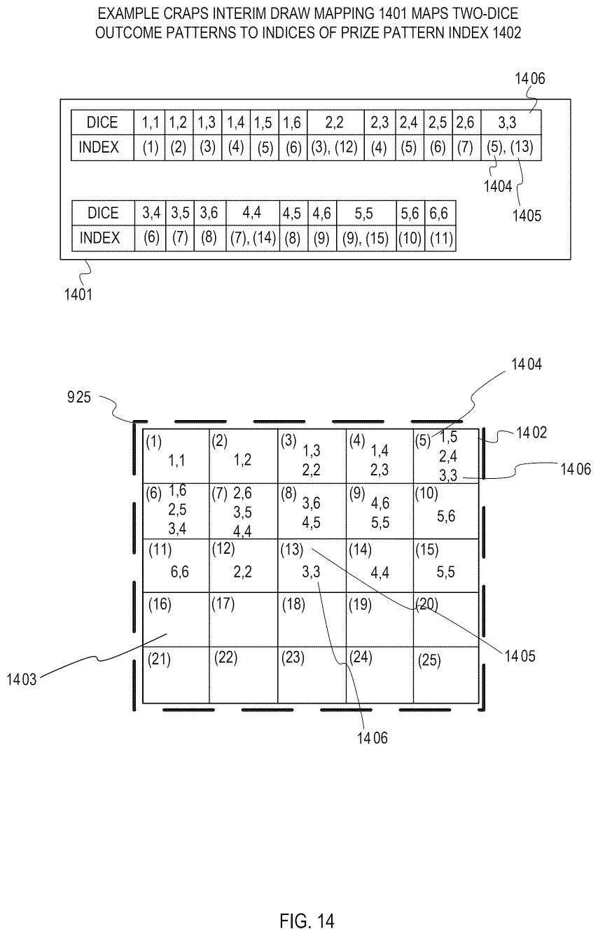

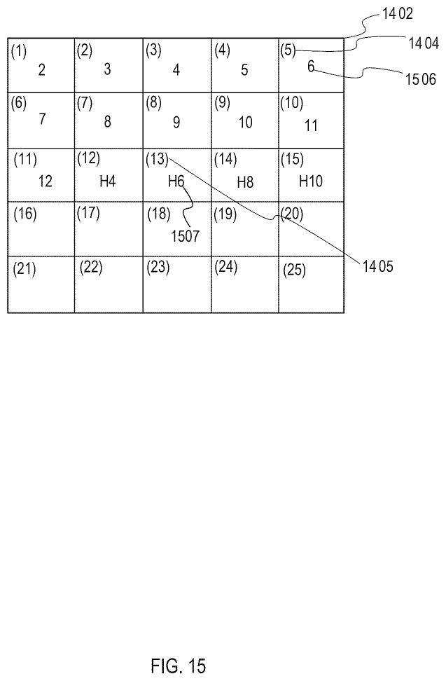

For craps, sicbo, or other games, the interim draw mapping includes a one-to-many mapping (e.g., see FIG. 14 and FIG. 19 respectively) to more than one prize pattern index value, based on craps and/or sicbo specific rules regarding relationships between dice outcomes and the available bet patterns (e.g., available bet-layout positions). For instance, for the games of craps or sicbo, the interim draw mapping can include a one-to-many correspondence of at least some possible outcomes of multiple randomizing devices (e.g., at least one multiple-die outcome) to two or more index values on the prize pattern index. By correlating at least one multiple-randomizing-device outcome to more than one index value via the prize pattern index permits the same outcome to map to more than one selectable bet pattern or bet type. For example, in craps and/or sicbo, because multiple dice are used as the randomizing device, in some instances multiple types of bets may depend on the dice being the same specific combined number (e.g., the die faces add up to a combined value of “6”). For example, as shown in the table 1301 of FIG. 13, in craps a first type of selectable bet pattern (first bet pattern type 1311) involves a “single outcome place bet,” or rather a bet that the outcome will result in a total sum of a certain value (e.g., of 6). A single outcome place bet on the value of 6 is referred to as a “place bet of ‘6’” which, as shown in the example 1321, includes a bet on an outcome of “6” where the configuration of the dice either “5” on one die and “1” on the other, “4” on one die and “2” on the other, or “3” on both dice (double threes). Furthermore, in craps a second type of selectable bet pattern (second bet pattern type 1312) involves a “single outcome-hardway bet,” (or “hardway bet”), which is a bet that the two-dice outcome will result in a total sum of a certain value (e.g., of 6) but only when the dice outcome shows doubles of the same value on each die (e.g., when double threes show on the dice). For example, the example 1322 illustrates an example of a hardway bet of 6, which would include only the value of double threes. A third type of selectable bet pattern 1313 (a craps bet) maps to examples of craps outcomes (e.g. as shown in the example 1323 includes the values of “2,” “3,” or “12”). A fourth type of selectable bet pattern 1314 involves a “group field bet” or rather a bet on a group of possible outcomes (e.g., as shown in example 1324, a bet on the values “2,” “3,” “4,” “9,” “10,” “11,” or “12”). However, as can be seen, some possible outcomes can map to different bet types. For example, the outcome of double threes can map to two different types of bets—the single outcome place bet of 6 and the hardway bet of 6. Thus, because the dice outcome of double threes can be used for two different types of bets, then the interim draw mapping 1401 (e.g., see FIG. 14) includes a draw mapping that can map the same outcome value (double threes) to two different index values (index 1404 and index 1405) within prize pattern index 1402. This provides more than one interim prize pattern entry for the same outcome. For example, as shown in FIG. 14, the same dice outcome value 1406 (which corresponds to the dice outcome of double threes) correlates, via the interim draw mapping 1401, to two separate entries 1404 and 1405 for respective array index values “(5)” and “(13)” of the prize pattern index 1402 Furthermore, it should be noted that because of the one-to-many nature of the mapping, the size of the prize pattern index 1402 requires only fifteen index entries (i.e., entries for indices “(1)”=through “(15)” inclusive). However, the template 925 (which is patterned after the 5×5 grid required for a single bingo card) has twenty-five spaces/entries. Thus, the prize pattern index 1402 is constructed using the template 925 to be the same size as a single bingo card, having five columns and five rows to permit each of the plurality of selectable bet patterns to be listed in at least one entry of the prize pattern index 1402 with any remainder entries being left unmapped. Because less than twenty-five entries are required to enact the interim draw mapping 1401, the prize pattern index 1402 includes two uncorrelated (e.g., unmapped) remainder rows encompassing entries for index values (16) through (25) inclusive. Furthermore, although the correlated entries are included in the top three rows, in other embodiments, the positions of the uncorrelated entries can be placed in a different configuration than that shown (e.g., randomly, in a manner that defines a certain shape or configuration, etc.). FIG. 15 illustrates an alternative version of the prize pattern index 1402 where instead of showing the one-to-many mappings of multiple dice outcomes per index entry, the prize pattern index 1402 in FIG. 15 shows generalized dice outcomes and/or abbreviations of a particular outcome. For instance, the entry 1404 (associated with index value “(5)”) is associated with three different actual two-dice combinations (i.e., the combination of “1” and “5,” the combination of “2” and “4” and the combination of “3” and “3” as shown in FIG. 14), which each add up to the value of “6.” Thus, the prize pattern index 1402 is shown in FIG. 15, shows a generalized value 1506 which represents that the various two-dice outcomes that result in the value “6.” Similarly, entries for index values “(12),” “(13),” “(14),” and “(15)” display, respectively, the values “H4,” “H6,” “H8,” and “H10,” which are abbreviations for outcomes of hardway bets of 2, 6, 8, or 10. Thus, for instance, the entry 1405 for index value “(13)” can either show the actual value (e.g., the “3,3” outcome value shown in FIG. 14) or the abbreviated bet type (e.g., as in FIG. 15, the value 1507 shows the abbreviation “H6” meaning a hardway 6 bet outcome, which is equivalent to the “3,3” outcome).

For the game of sicbo, as shown in FIG. 19, interim draw mapping 1901 includes mappings that correlate individual one, two, or three-dice outcomes to one or more of the index values for prize pattern index 1902. For example, as shown in the interim draw mapping 1901, the selectable bet patterns for sicbo involve one or more of the following: (i) a single outcome on a single die (6 possible outcomes); (ii) any two-dice combination (21 possible outcomes); (iii) any 3-dice sum (14 possible outcomes); (iv) a specific triple dice outcome (6 possible outcomes), (v) any triple dice outcome (1 possible outcome), (vi) a small score value excluding any triple (1 possible outcome), and/or (vii) a big score value excluding any triple (1 possible outcome). Thus, the fifty possible outcomes (according to the rules of sicbo) are correlated to specific interim prize spaces on a prize pattern index 1902, which is used to map bingo ball draws to an interim prize pattern. Within the prize pattern index 1902, the index values are correlated as follows: (i) single one-die outcomes of any individual number from “1” to “6” (6 total outcomes) is correlated respectively to indices “(1)” through “(6)” inclusive; (ii) two-dice outcomes combinations (21 outcomes) are correlated respectively to indices “(7)” through “(27)” inclusive; (iii) any three dice sum from 4 to 17 (14 outcomes) are correlated respectively to indices “(28)” through “(41)” inclusive; (iv) each triple dice (6 outcomes) is correlated respectively to indices “(42)” through “(47)” inclusive; (v) any triple dice (1 outcome) is correlated to index “(48)”; (vi) any three-dice score whose sum falls within a small range (e.g., from 4-10) is correlated to index “(49)”; and (vii) any three-dice score whose sum falls within a large range (e.g., from 11-17) is correlated to index “(50)”. The size of the prize pattern index 1402 requires fifty index entries (i.e., entries (1)-(50)). The template 925 (which is patterned after the 5×5 grid required for a single bingo card) has twenty-five spaces/entries. Thus, the prize pattern index 1902 is constructed using the template 925 to be the same size as a two bingo cards, having five columns and ten rows to permit each of the plurality of selectable bet patterns to be listed in at least one entry of the prize pattern index 1902 with no remainder entries being left uncorrelated. Furthermore, FIG. 19 illustrates only one example interim draw mapping 1901 for sicbo. Other example interim draw mappings could correlate the selectable bet patterns to different index values other than those shown (e.g., randomly, in a manner that defines a certain shape or configuration, etc.).

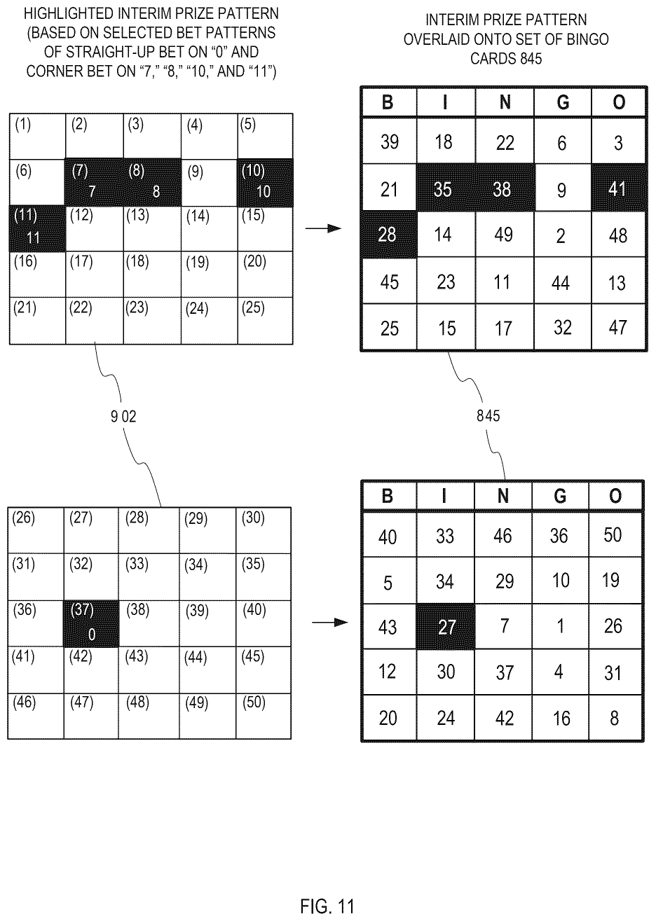

The processor performs the second prize pattern index determination operation, for example, by selecting, as the interim prize pattern, entries on the prize pattern index that correspond to at least one index value correlated with a selected betting pattern. The selecting correlates a set of prize pattern index entries for the interim prize pattern to a corresponding set of bingo-card entries on a bingo card (e.g., the corresponding set of bingo-card entries have a set of bingo-grid entries that correspond in position to an equivalent set of prize pattern index values for a set of entries of the selected one or more selectable bet patterns). For example, in FIG. 11, the processor detects a selected bet pattern (by the player) on a straight up bet on the value “0” as well as a corner bet on the collective values of “7,” “8,” “10,” and “11.” Thus, the processor selects the interim prize pattern based on one or more correlated index value(s) of the interim draw mapping 901. The interim prize pattern equates to the highlighted entries for index values “7,” “8,” “10,” “11,” and “37.”

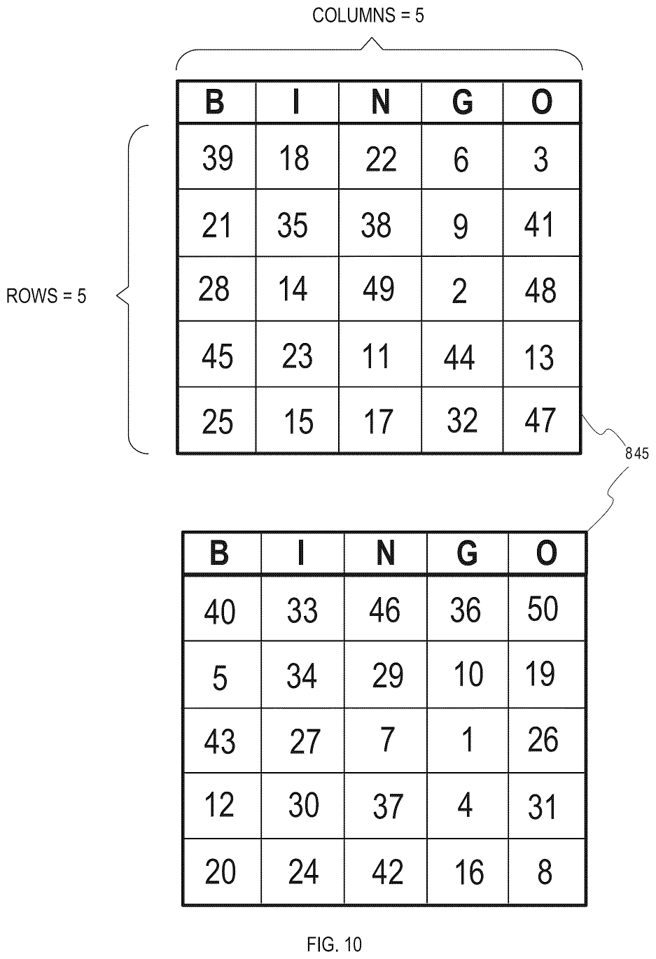

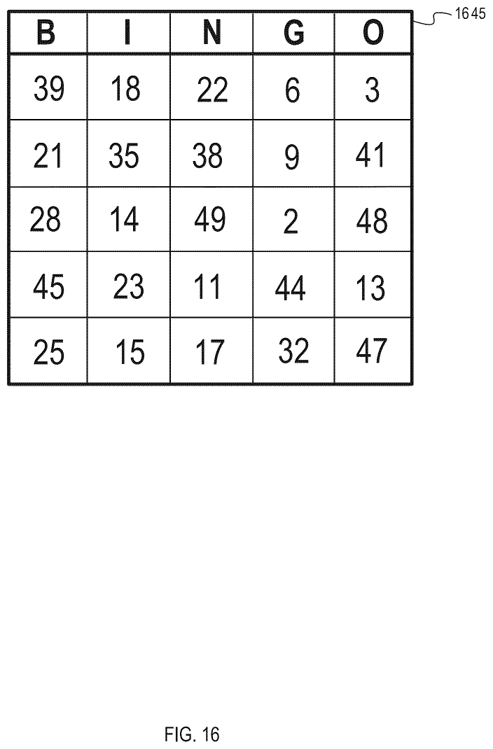

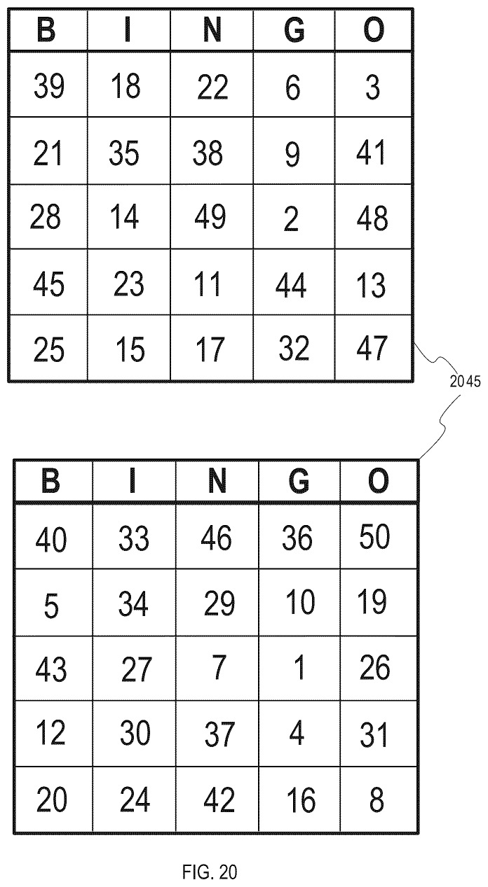

Referring momentarily back to FIG. 7, the flow 700 continues at processing block 706, where a processor generates a set of bingo cards with random bingo numbers. For example, a processor (e.g., of bingo manager 310) generates a set of bingo cards for a particular player, where the set of bingo cards has one or more player cards (depending on the number of required index entries of the prize pattern index per game rules), each having randomly selected numbers corresponding to ball draws numbers (e.g., numbers 1 through 75) placed on spaces of the card. FIG. 10 illustrates an example of a set of bingo cards 845 generated for the roulette game according to the interim draw mapping 901. FIG. 16 illustrates an example of the set of bingo cards 845 required for the craps game according to the interim draw mapping 1401. FIG. 20 illustrates an example of the set of bingo cards 2045 required for the sicbo game according to the interim draw mapping 1901.

As mentioned, the total number of rows within a prize pattern index may be less or more than a total number of rows available on a single bingo card (e.g. less or more than 5 rows). More specifically, in at least one embodiment, the processor generates a number of bingo cards (i.e., player cards) in the set of bingo cards based on a size of the prize pattern index, where the size of the prize pattern index depends on at least (1) the number of predetermined possible outcome patterns that are correlated and (2) a standard bingo-card grid size. Because the set of bingo cards use a standard bingo-card grid size having a set number of columns, the size of the prize pattern index is constructed/correlated to have the same number of columns (e.g. according to the number of columns in the template 925). However, the number of rows in the prize pattern index is based on two factors: (1) the number of rows must be large enough to correlate each of the predefined outcome patterns (per game rules) of the randomizing device to at least one entry in the prize pattern index, and (2) the number of rows of the prize pattern index is a multiple of a required number of rows in the standard grid (e.g., based on use of the template 925). For the example of a 5×5 grid size, if more than 5 rows are included in the prize pattern index, then more than one player card will be generated/provided in the set of bingo cards. Thus, in one embodiment, the number of bingo cards in the set of bingo cards to be generated/provided is based on the number of rows in the prize pattern index divided by a number of rows on a single bingo-card grid. For example, in FIG. 9, the template 925 for the grid is a 5×5 array, having five columns and five rows. Thus, the template 925 can only encompass twenty-five entries (i.e., 5×5=25) of the interim draw array. In order to encompass the thirty-seven different selectable bet patterns required for the roulette interim draw mapping 901 two bingo cards are required in the set of bingo cards 845 (e.g., the first bingo card in the set encompassing entries for index values “(1)” through “(25)” and the second bingo card in the set encompassing the index values “(26)” through “(50)”). Referring to FIG. 16, only one bingo card is required in the set of bingo cards 1645 to encompass the fifteen different predetermined outcomes for the selectable bet patterns associated with the craps rules. Furthermore, referring to FIG. 20, two bingo cards are required in the set of bingo cards 2045 to encompass the fifty different outcomes for the selectable bet patterns associated with the sicbo rules.

Referring momentarily back to FIG. 7, the flow 700 continues at processing block 708, where a processor overlays, via a display associated with the wagering game, the interim prize pattern onto the set of bingo cards. For example, as illustrated in FIG. 11, a processor selects index entry locations of the prize pattern index 902 that corresponds to the selected bet patterns for a straight up bet on “0” and the corner bet on “7,” “8,” “10,” and “11.” The processor (e.g., of a terminal or bingo game manager) overlays, via a display associated with the wagering game, the interim prize pattern onto the set of bingo cards 845, which creates one or instances (e.g., graphics) of one or more player cards for presentation via a display of a gaming terminal. For example, the processor overlays the interim prize pattern by highlighting (e.g., in black) spaces on the set of bingo cards 845 that correspond to respective entry locations for correlated index values of the interim prize pattern.

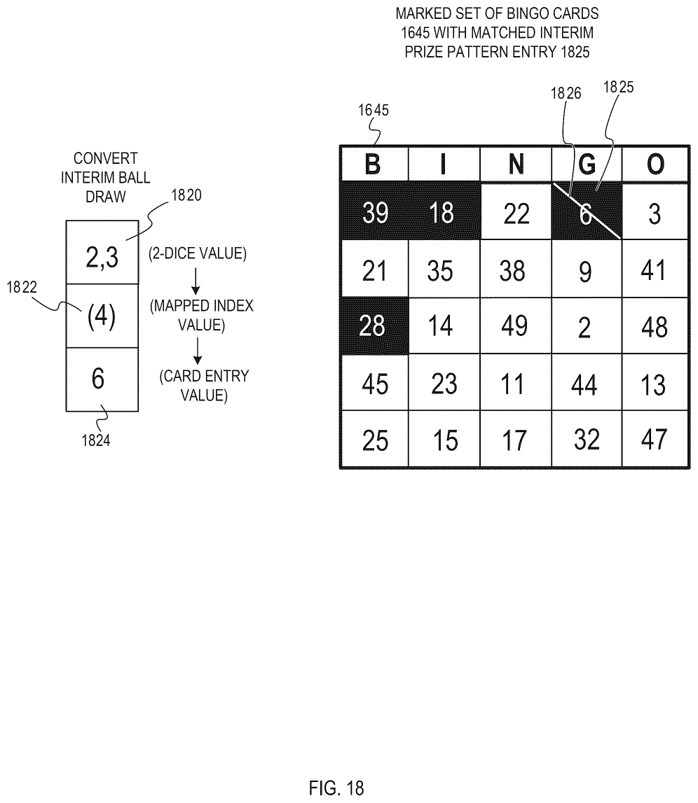

In another example, as illustrated in FIG. 18, a processor selects index entry locations of the prize pattern index 1402 that corresponds to the selected bet patterns for a place bet on 5 (corresponding to index entry “(4)”) and any craps bet (corresponding to the index entries “(1),” “(2)” and “(11)” assigned respectively to the craps outcomes of “2,” “3,” or “12” according to the craps interim draw mapping 1401). The processor overlays, via a display associated with the wagering game, the interim prize pattern by highlighting (e.g., in black) spaces on the set of bingo cards 1645 that correlate to the respective entry locations for the mapped index values of the interim prize pattern.

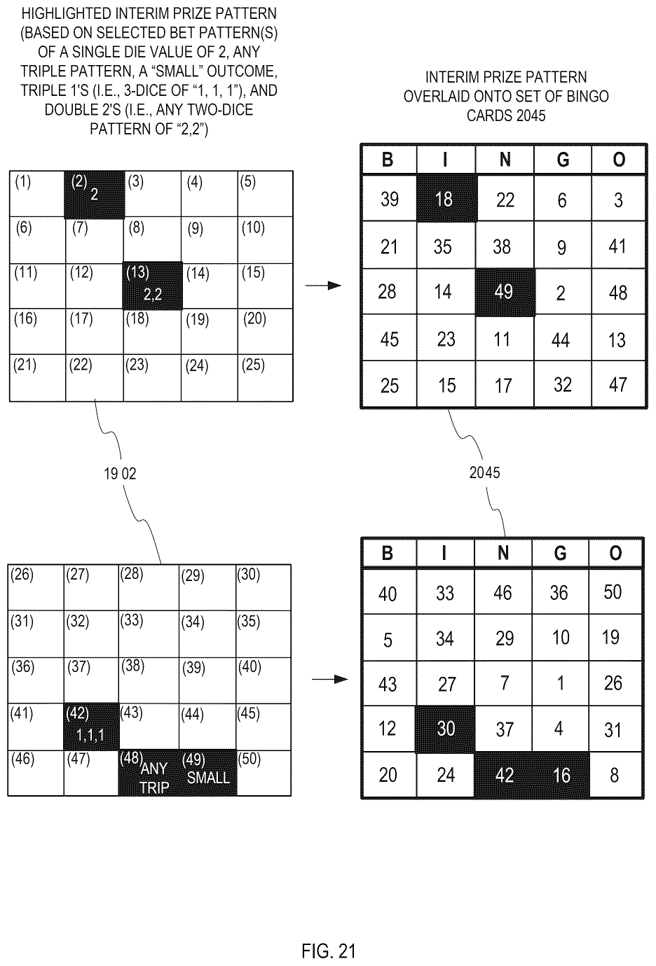

In yet another example, as illustrated in FIG. 21, a processor selects index entry locations of the prize pattern index 1902 that corresponds (via interim draw mapping 1901) to the selected bet patterns for a single die value of “2,” Any Triple, a Small outcome, a Triple 1's outcome (i.e., 3-dice of “1, 1, 1”), and double 2's (i.e., any two-dice of “2,2”) which corresponds, respectively, to the index entries “(2),” “(13),” “(42),” “(48)” and “(49).” The processor overlays, via a display associated with the wagering game, the interim prize pattern by highlighting (e.g., in black) spaces on the set of bingo cards 2045 that correspond to the respective entry locations for the correlated index values of the interim prize pattern.

In one embodiment, the processor can modify visible characteristics of entries for the interim prize pattern on the bingo card with a different effect or visible characteristic (e.g., a different color) to indicate a relationship between the bet type (or type of bet pattern) in the primary game with a potential level or reward or payout of the interim prize. For example, the processor can enhance entries on the interim prize patter to reflect the risk value for the bet in the primary game, to identify a greater potential payout of the interim prize if drawn/marked, etc. In one example, the processor enhances the entry when the bet pattern for that bet type is selected (e.g., when the bet pattern is selected, via player input, from a betting layout presented at the player terminal prior to all bets being closed in the primary game). In some embodiments, the enhancement/visible characteristic is locked in when bets are closed and the player has completed selection of their bet type/betting pattern. For example, if a player makes four straight up bets on each of “7,” “8,” “10,” and “11,” for a Roulette game, the processor modifies the identifying visible characteristic of the interim-prize-pattern entries to indicate a potential for a greater payout or an enhancement (e.g., adjusts a background color for each of the highlighted bingo-card entries to be a first color—e.g., “red”) whereas for entries associated with a multi-value bet type (e.g., corner bet that covers each of “7,” “8,” “10,” and “11,”) the processor modifies the identifying visible characteristic of the interim-prize-pattern entries to indicate the potentially lower payout or enhancement (e.g., adjusts a background color for the entries to be a second color—e.g., blue). By adjusting or modifying a visible characteristics of an interim-prize-pattern entry, the bingo system incentivizes placement of higher risk bets in the primary game (e.g., resulting in more bet revenue the Roulette game), by providing a clear visible indicator to the player, during the betting phase of the wagering game, that selection of a higher risk bet pattern in the wagering game (e.g., in the Roulette game) would result in a greater potential interim prize award amount, or a potential for additional enhancements, in the bingo game.

In some embodiments, the processor can further enhance an entry with an increased potential reward by associating an additional reward with a higher risk bet pattern, such as by adding an interim-prize enhancer (e.g., a “free game” entry, a multiplier, etc.). For example, the processor can present a “free-game” or “multiplier” indicator on/at prize pattern index entry for a single-value bet type (e.g., a straight-up bet pattern). If that entry is drawn/marked then the interim prize can payout the enhancement in addition to the interim prize amount (or the enhancement can be associated with the payout factor of the interim prize amount). In one embodiment, the enhancement can be identified in a legend that describes the enhancement being associated with the visible characteristic of the entry (e.g., a legend indicates that “red” colored entry carries a higher potential payout and/or an interim prize enhancement).

Referring momentarily back to FIG. 7, the flow 700 continues at processing block 712, where a processor detects a game outcome pattern by a randomizing device for wagering game. In one embodiment, the processor detects the game outcome pattern by communicating with a random number generator (RNG) of an electronic game system (e.g., run by bingo game manager 310, run by game controller 210, run by control processor 197, etc.) according to a randomizing algorithm that matches randomization characteristics of the randomizing device. In another embodiment, the processor detects the game outcome pattern by computerized analysis of image data captured of the randomizing device at a gaming table. For example, FIG. 23 illustrates an example gaming system 2300 for implementing wagering games at a gaming table. The gaming system 2300 includes a table 1682 at which a randomizing device may be displayed and activated (e.g., within player area 1687) during a playing round of a wagering game (e.g., roulette, poker, craps, etc.). Rather than the randomizing device outcome pattern being determined by computerized random processes, a physical randomizing device (e.g., a standard 52-card deck of playing cards, a set of standard playing dice, a roulette wheel, etc.) may be activated by a live dealer 1680 (e.g., dealt by live dealer 1680, rolled by live dealer 1680, spun by live dealer 1680, etc.) at the table 1682 (e.g., dealt from a card-handling system 1684, activated via an electronic dice popper, spun by pressing a button on a dealer terminal 1688, etc.). The table 1682 and dealer 1680 are located in a studio or on a casino floor. Dealer terminal 1688 provides authorized access by the dealer 1680 to functionality of the gaming system 2300. In some embodiments, a table manager terminal 1686 may assist the dealer 1680 in facilitating play of the game by transmitting instructions to the dealer terminal 1688, by transmitting a live video feed of the dealer's actions to a user device 1620, by transmitting remote player elections to the dealer 1680, etc. The table manager terminal 1686 may act as or communicate with a gaming system (e.g., system 600, system 500, system 300, etc.) or as an intermediate client interposed between and operationally connected to the user device 1620 and the gaming system to provide gaming at the table 1682 to users of the gaming system 2300. Thus, the table manager terminal 1686 may communicate with the user device 1620 through a network and may be a part of a larger online casino or may be operated as a separate system facilitating game play. In some embodiments, the table manager terminal 1686 includes and/or incorporates the game controller 210 (e.g., see FIG. 2) instead of, or in addition to, the dealer terminal 1688. In various embodiments, each table 1682 may be managed by an individual table manager terminal 1686 constituting a gaming device, which may receive and process information relating to that table. For simplicity of description, these functions are described as being performed by the table manager terminal 1686, though certain functions may be performed by an intermediary gaming system, such as system 600, system 500, system 300, etc. In some embodiments, the gaming system 2300 may match remotely located players to tables 1682 and facilitate transfer of information between user devices 1620 and tables 1682, such as wagering amounts and player option elections, without managing gameplay at individual tables.

The table 1682 includes a camera 1670 and, optionally a microphone 1672, to capture video and audio feeds relating to the table 1682. The camera 1670 may be trained on the live dealer 1680, play area 1687, and card-handling system 1684. As the game is administered by the live dealer 1680, the video feed captured by the camera 1670 may be shown to the player remotely using the user device 1620, and any audio captured by the microphone 1672 may be played to the player remotely using the user device 1620. In some embodiments, the user device 1620 may also include a camera, microphone, or both, which may also capture feeds to be shared with the dealer 1680 and other players. In some embodiments, the camera 1670 may be trained to capture images of the randomizing device (e.g., card faces, dice faces, roulette wheel segments, etc.), chips, and chip stacks on the surface of the gaming table. Image extraction techniques may be used to obtain information about the outcome of a randomizing device (e.g., information about card count and card rank and suit information from the card images, information about dice rolls, information about roulette wheel spins, etc.) and/or to track other useful game activities, such as wager data.

Randomizing device data and wager data in some embodiments may be used by the table manager terminal 1686 to determine game outcome. The data extracted from the camera 1670 may be used to confirm the randomizing device data, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play.

In one embodiment that uses a live video feed, the live video feed permits the dealer to show randomizing device outcomes (e.g., cards dealt by the card-handling system 1684, dice rolled, roulette wheel spun and stopped, etc.) and play the game as though the player were at a gaming table, playing with other players in a live casino. In addition, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players. In one embodiment, the play area 1686 depicts player layouts for playing the game. The player area 1686 may also include sections for presentation and activation of randomizing devices. As determined by the rules of the game, the player at the user device 1620 may be presented options for responding to an event in the game using a client as described with reference to FIG. 1.

The table 1682 also includes a projector 1671 to project gaming content at a surface of the table 1682, including video images of physical randomizing devices, images of virtual randomizing devices, etc.

Player elections may be transmitted to the table manager terminal 1686, which may display player elections to the dealer 1680 using a dealer display associated with a dealer terminal 1688 and player action indicator 1690 on the table 1682. For example, the display of the dealer terminal 1688 may display information regarding where to deal the next card or which player position is responsible for the next action. In some embodiments, the dealer terminal 1688 has access to game rules. Furthermore, in some embodiments, the dealer terminal 1688 is jurisdictionally authorized to (e.g., possesses jurisdictionally authorized code to) store game outcome information that can be referred to in case of device malfunctions or disputes.

In some embodiments, the table manager 1686 may receive card information from the card-handling system 1684 to identify cards dealt by the card-handling system 1684. For example, the card-handling system 1684 may include a card reader to determine card information from the cards. The card information may include the rank and suit of each dealt card and hand information.

The table manager 1686 may apply game rules to the card information, along with the accepted player decisions, to determine gameplay events and wager results. Alternatively, the wager results may be determined by the dealer 1680 and input to the table manager terminal 1686, which may be used to confirm automatically determined results by the gaming system.

Card and wager data in some embodiments may be used by the table manager terminal 1686 to determine game outcome. The data extracted from the camera 1670 may be used to confirm the card data obtained from the card-handling system 1684, to determine a player position that received a card, and for general security monitoring purposes, such as detecting player or dealer card switching, for example.

The live video feed permits the dealer to show randomizing device outcomes (e.g., cards dealt by the card-handling system 1684, dice rolled within a dice popper, a spun roulette wheel, etc.) and play the game as though the player were at a live casino. In other embodiments, the system 2300 can be used in a live casino. In addition, in one embodiment, the dealer can prompt a user by announcing a player's election is to be performed. In embodiments where a microphone 1672 is included, the dealer 1680 can verbally announce action or request an election by a player. In some embodiments, the user device 1620 also includes a camera or microphone, which also captures feeds to be shared with the dealer 1680 and other players.

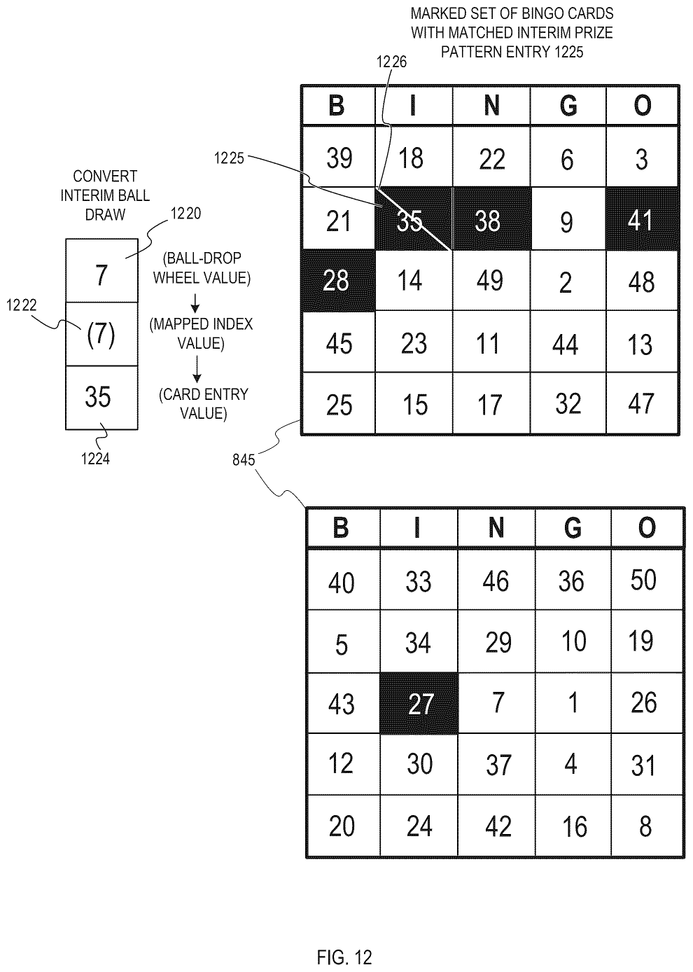

Referring momentarily back to FIG. 7, the flow 700 continues at processing block 714, where a processor converts, using the prize pattern index and/or the interim draw mapping, the detected game outcome pattern to interim ball draw(s). For example, in FIG. 12, a roulette game outcome is converted using the interim draw mapping 901. For instance, a processor detects a randomizing device outcome, such as the outcome value 1220 of a roulette wheel spin. The outcome value 1220 is the value “7,” meaning that the ball 813 landed in the pocket 899 associated with the wheel segment assigned to the value “7” on the wheel 850 (see FIG. 8). The processor refers to the interim draw mapping 901 to determine that the outcome value 1220 (i.e., the value “7” on the roulette wheel) is mapped to index value 1222 (i.e., mapped to the index value “(7)” on the prize pattern index 902). In one embodiment, the bingo game manager 310 generates the outcome and converts the outcome to the appropriate mapped index value using the interim draw mapping 901. The bingo game manager 310 then sends the mapped index value to a player terminal. The player terminal then determines a card space value 1224 whose location is at the mapped index value. For example, the card space value 1224 is the value “35” located at entry 1225 of the set of bingo cards 845, which entry 1225 corresponds to the mapped index value 1222 (e.g., corresponds to index value “(7)”).

FIG. 18 illustrates an example of converting an interim ball draw for a craps game. In FIG. 18, a craps game outcome is converted using the interim draw mapping 1401. For instance, the processor detects a randomizing device outcome, such as the outcome value 1820 of two dice. The outcome value 1820 is the value “2,3,” meaning that for the two-dice outcome, one die had landed a “2” face value and the other had landed a “3” face value. The processor refers to the interim draw mapping 1401 to determine that the outcome value 1820 (i.e., the value “2,3” on the dice) is mapped to index value 1822 (i.e., mapped to the index value “(4)” on the prize pattern index 1402). In one embodiment, the bingo game manager 310 generates the outcome and converts the outcome to the appropriate mapped index value using the interim draw mapping 1401. The bingo game manager 310 then sends the mapped index value to a player terminal. The player terminal then determines a card space value 1824 whose location is at the mapped index value. For example, the card space value 1824 is the value “6” located at entry 1825 of the set of bingo cards 1645, which entry 1825 corresponds to the mapped index value 1822 (e.g., corresponds to index value “(4)”).

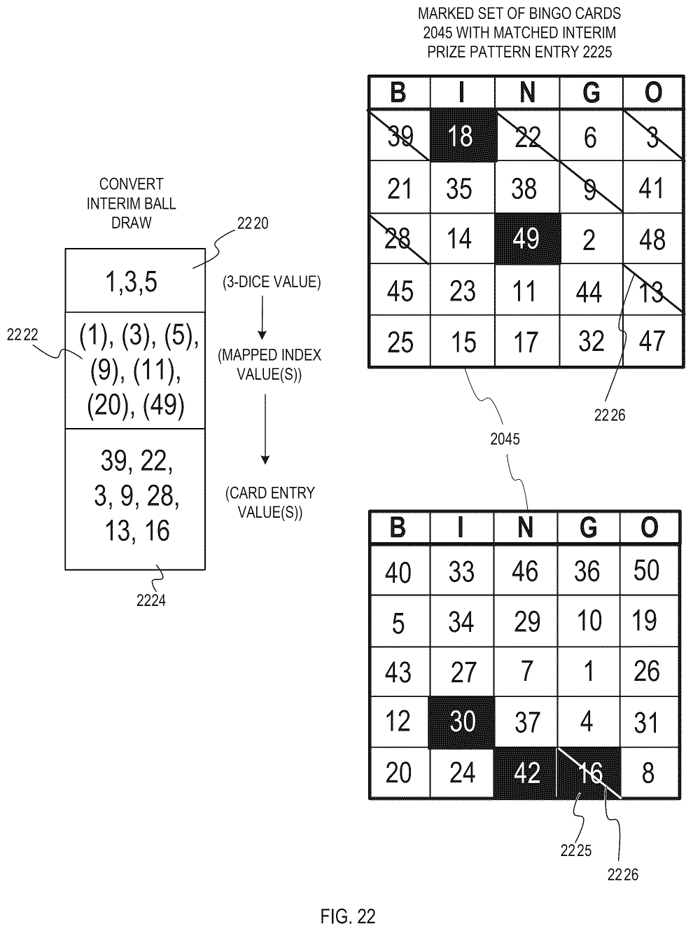

FIG. 22 illustrates an example of converting an interim ball draw for a sicbo game. In FIG. 22, a sicbo game outcome is converted using the interim draw mapping 1901. For instance, the processor detects a randomizing device outcome, such as the outcome value 2220 of three dice. The outcome value 2220 is the value “1,3,5,” meaning that for the three-dice outcome, one die had landed a “1” face value, a second had landed a “3” face value, and the third had landed a “5” face value. The processor refers to the interim draw mapping 1901 to determine that the outcome value 2220 (i.e., the value “1,3,5” on the dice) is mapped to multiple index values 2222 (i.e., the three-dice value “1,3,5” maps to the index values “(1),” “(3),” “(5),” “(9),” “(11),” “(20),” and “(49)” on the prize pattern index 1902). In one embodiment, the bingo game manager 310 generates the outcome and converts the outcome to the appropriate mapped index values using the interim draw mapping 1901. The bingo game manager 310 then sends the mapped index values to a player terminal. The player terminal then determines card space values 2224 whose locations are at the respective mapped index values. For example, the card space values 2224 include the space values “39,” “22,” “3,” “9,” “28,” “13,” and “16” at various entries of the set of bingo cards 2045, which entries corresponds to the mapped index values 2222 (e.g., correspond to index values “(1),” “(3),” “(5),” “(9),” “(11),” “(20),” and “(49)”).

Referring momentarily back to FIG. 7, the flow 700 continues at processing block 716, where a processor marks entry (ies) on the set of bingo cards corresponding to index position(s) of interim ball draw(s). For example, referring to FIG. 12, for the game of roulette, after a processor determines that wheel outcome 1220 (i.e., the value of “7”) maps, via interim draw mapping 901, to the mapped index value 1222 (i.e., to the index value “(7)”), which in turn corresponds to card entry value 1224 at entry 1225, the processor then marks the entry 1225 with marker 1226. Referring to FIG. 18, for the game of craps, after a processor determines that the two-dice outcome 1820 maps, via interim draw mapping 1401, to the mapped index value 1822, which in turn corresponds to card entry value 1824 at entry 1825, the processor then marks the entry 1825 with marker 1826. Referring to FIG. 22, for the game of sicbo, after a processor determines that the three-dice outcome 220 maps, via interim draw mapping 1901, to the mapped index values 2222, which in turn corresponds to card entry values 2224 at various corresponding entries on the set of bingo cards 2045, the processor then marks the various corresponding entries (including entry 2225) with markers 2226.

Referring momentarily back to FIG. 7, the flow 700 continues at processing block 720, where a processor determines whether the interim prize pattern is matched to at least one of the interim ball draw(s). In one embodiment, the processor determines whether a placed marker (e.g., marker 1226 in FIG. 12, marker 1826 in FIG. 18, or markers 2226 in FIG. 22) intersects (i.e., has same coordinates, has same index value, etc.) with an entry that was highlighted with the interim prize pattern. In one embodiment, the bingo game requires M number of marked positions on the bingo card to match the Interim Prize pattern. In one example, the value M can be 1 (i.e., only one marked position needs to match to win the interim prize). In other examples, the value M can be more than 1 (e.g., multiple marked positions need to match to win the interim prize). In other words, if M number of marked/required positions on the bingo card match (intersect) with the interim prize pattern, the player has achieved an interim bingo and the flow 700 continues to processing block 722 where a processor animates an interim prize award value based on the selected bet pattern. For example, the processor evaluates the player wager positions (i.e., evaluates the selected one(s) of the selectable bet patterns) in accordance with the game rules, wager rules, etc. Via the evaluation, the processor determines the characteristics of the selected bet pattern (e.g., the type, level, risk, etc.), The processor uses the determined characteristic(s) of the selected bet pattern (e.g., based on the type, level, risk, etc. of the selected bet pattern) to generate an interim prize award value. For example, in FIG. 12, the bingo game requires only one marked position on the bingo card to match one of the interim prize pattern to win the interim prize (e.g., M=1). This enables the bingo system to adjust a payout structure (e.g., a payout table) for the bingo game based on a type or degree of bet made (e.g., based on a level of odds associated with a bet, based on a bet level for the bet, etc.). For example, for the roulette game, a single-value bet pattern (i.e., a straight-up bet type) has a statistically lower odds of occurrence on the roulette wheel than for a multi-value bet type (e.g., a corner bet type, a group bet type, etc.). For example, the odds of occurrence of a straight up bet (for example on the value “0”) is 1/37 (for a wheel having values 1-36 and 0), which is relatively lower odds of occurrence than a corner bet on any of the four values “7,” “8,” “10,” and “11,” which wins if any of the cornet bet outcomes occur (i.e. a 4/37 chance of occurring). Thus, according to the Roulette rules, the payout on the multi-value bet pattern is relatively lower (e.g., for times lower) than for a single-value bet pattern payout. Thus, the bingo game system can provide a more exciting and/or rewarding experience in the bingo game by adjusting (e.g., prorating, making proportionately higher, enhancing, etc.) the payout factor in the bingo game based on the type of bet pattern selected. For example, in the wagering game (i.e., the Roulette game), if four single-value type bets (i.e., straight up bet types) are placed on each of “7,” “8,” “10,” and “11,” the processor can apply to each corresponding index value on the interim prize pattern (for each index value correlated to “7,” “8,” “10,” and “11”) a payout factor that is adjusted higher based on the relatively higher degree of risk in the roulette game on each individual roulette number. On the other hand, for placement of a multi-value type bet (e.g., a corner bet that covers the values “7,” “8,” “10,” and “11”), then the processor would apply to each corresponding index value on the interim prize pattern (for each index value correlated to “7,” “8,” “10,” and “11”) a payout factor that is adjusted lower based on the relatively lower degree of risk in the primary game for the corner bet. A payout factor for the corner bet thus provides a payout amount of the interim prize that is related (e.g., proportional to, prorated by, etc.) the chances of occurrence in the bingo game.

Furthermore, in response to the processor generating the interim prize award value based on the selectable bet pattern, the processor presents an animation (e.g., a highlight effect) that indicates that the interim prize was achieved. For example, referring to FIG. 8, the player terminal 801 presents a highlight effect via the set of bingo cards 845 presented on the display 803 (e.g., a matched entry on the set of bingo cards 845 lights up). In another embodiment, the processor can present a highlight effect via the layout 820 (e.g., the betting spot 888 lights up or performs a payout effect indicating association with the interim prize for the bingo game). In one embodiment, the layout may include settings or user-input controls to buy in to the bingo game, an option to control highlighting settings or preferences (e.g., an option to select highlight effects that appear in association with the set of bingo cards 845, an option to control whether highlight effects are shown on the layout 820), etc.

FIG. 7, described by way of examples above, represents one or more algorithms that correspond to at least some instructions stored and executed by the game-logic circuitry associated with any of the systems or devices described, for example in FIG. 1, FIG. 2, FIG. 3, FIG. 4, FIG. 5, FIG. 6, FIG. 8, or FIG. 23, to perform the above described functions associated with the disclosed concepts.

Any component of any embodiment described herein may include hardware, software, or any combination thereof.

Further, the operations described herein can be performed in any sensible order. Any operations not required for proper operation can be optional. In addition, other embodiments involve variations to the operations, such as, in FIG. 7, the prize pattern index can correlate locations of entries/index values (for predetermined outcomes of a primary randomizing device) related to a primary game of chance to corresponding locations of entries/index values of any type of secondary-game array or grid for any type of secondary game of chance similar to bingo (e.g., keno, lottery, slingo, pokeno, raffle draws, etc.), which secondary-game array has entries (similar to that of a bingo card) associated with outcomes for a secondary randomizing device (e.g., random ball draws) of the secondary game. As such, at least in some embodiments, the operations and/or systems described herein are an improvement to gaming technologies (e.g., to a gaming machine or gaming table) by mapping an event position on an array of a secondary game of chance according to correlated position on an index of the primary game (e.g., mapping a position on secondary game array for an interim prize pattern according to a correlated index position for a selected bet pattern of a randomizing device for the primary game). In one instance, this improvement increases the ability of the gaming device to provide, automate, and/or integrate multiple types of games using an integrated gaming resource or element. Further, all methods described herein can also be stored as instructions on a computer-readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

Features of various embodiments of the inventive subject matter described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments which are defined only by the appended claims. Further, since numerous modifications and changes may readily occur to those skilled in the art, it is not desired to limit the inventive subject matter to the exact construction and operation illustrated and described, and accordingly all suitable modifications and equivalents may be resorted to, falling within the scope of the inventive subject matter.

What is claimed is:

1. A method of operating a bingo game system comprising:
detecting, by a processor in response to user input received in association with a terminal of an electronic gaming system, a selection of a bet pattern for a wagering game,
determining, by the processor based on selected bet pattern and prize pattern index, an interim prize pattern for a bingo game associated with the wagering game;
providing, via a bingo game server to the terminal, a set of bingo cards generated based on a size of the prize pattern index;
overlaying, by the processor via a display associated with the electronic gaming system, the interim prize pattern onto the set of bingo cards;
detecting, by the processor, one or more outcome patterns of a randomizing device for the wagering game;
converting, by the processor using the prize pattern index, the one or more outcome patterns of the randomizing device to one or more interim ball draws for the bingo game;
marking, by the processor via the display, each index position on a set of bingo cards that corresponds to an index position of any of the one or more interim ball draws; and
animating, in response to determination that a marked index position intersects the interim prize pattern, an interim prize award value according to the selected bet pattern.

2. The method of claim 1, wherein the selected bet pattern is one of a plurality of selectable bet patterns for the wagering game, wherein the plurality of selectable bet patterns corresponds to possible combinations of outcome patterns for the randomizing device that can be bet upon according to rules of the wagering game.

3. The method of claim 2, wherein determining the interim prize pattern comprises:
correlating, via an interim draw mapping for the plurality of selectable bet patterns, each of the plurality of selectable bet patterns to at least one of a plurality of index values on the prize pattern index; and
selecting a pattern of mapped index values on the prize pattern index that corresponds to at least one of the possible combinations of outcome patterns for the randomizing device that is associated with the selected bet pattern.

4. The method of claim 3, wherein overlaying the interim prize pattern onto the set of bingo cards comprises highlighting, via the display, spaces on a grid of the set of bingo cards that correspond to entries for the pattern of mapped index values.

5. The method of claim 4 further comprising constructing, by the processor, the size of the prize pattern index based on a required grid-size for the set of bingo cards.

6. The method of claim 3, wherein the interim draw mapping is a one-to-one correlation of each possible outcome pattern of the randomizing device to a respective unique index value on the prize pattern index.

7. The method of claim 3, wherein the interim draw mapping is a one-to-many correlation of at least some of the possible combinations of outcome patterns to one or more of a same index value on the prize pattern index or to more than one index value on the prize pattern index.

8. The method of claim 3, wherein animating the interim prize award value comprises determining, based on a type of bet, an amount of the interim prize award value, wherein the type of bet is based on one or more of a bet level or an odds of occurrence of the at least one of the possible combinations of outcome patterns for the randomizing device that is associated with the selected bet pattern.

9. The method of claim 1, wherein detecting the one or more outcome patterns of the randomizing device comprises detecting one or more outcome patterns of a random number generator using a randomizing algorithm that matches randomization characteristics of the randomizing device.

10. The method of claim 1, wherein detecting the one or more outcome patterns of the randomizing device is in response to computerized analysis, by the processor, of image data captured of the randomizing device at a gaming table.

11. A gaming system comprising:
an electronic gaming system having a plurality of gaming terminals; and
an electronic processor configured to execute instructions, which when executed by the processor cause the gaming system to perform operations to:
detect, in response to user input received in association at least one of the plurality of gaming terminals, a selection of a bet pattern for a wagering game;
animate, based on the selected bet pattern and a prize pattern index, an interim prize pattern on a set of bingo cards associated with the wagering game, wherein the interim prize index correlates, via an interim draw mapping, each of a plurality of predetermined outcome patterns of a randomizing device for the wagering game to one or more respective index values of the prize pattern index;
detect that a randomizing device for the wagering game produces a specific outcome pattern;
convert, using the prize pattern index, the specific outcome pattern of the randomizing device to at least one interim ball draw for the bingo game;
mark, via the display, at least one space on the set of bingo cards whose location maps to the one interim ball draw;
determine, using the interim draw mapping, that an index value of the at least one space on the set of bingo cards corresponds to at least one the one or more respective entries associated with the animated interim prize pattern; and
animate an interim prize award value based on a type of the selected bet pattern.

12. The gaming system of claim 11, wherein the electronic processor is configured to execute further instructions, which when executed by the processor cause the gaming system to perform further operations to generate a number of constituent bingo cards for the set of bingo cards based on a size of the prize pattern index, wherein each constituent bingo card in the set of bingo cards uses a standard bingo-card grid size having a set number of columns and a set number of rows, wherein the size of the prize pattern index includes the set number of columns and also includes a number of rows sufficient to correlate at least one entry in the prize pattern index to each of the plurality of possible outcome patterns, and wherein the number of rows is a multiple of the set number of rows in the standard bingo-card grid.

13. The gaming system of claim 11, wherein the plurality of predetermined outcome patterns of the randomizing device corresponds to possible combinations of outcome patterns for the randomizing device that can be bet upon according to rules of the wagering game.

14. The gaming system of claim 11, wherein the type of the selected bet pattern comprises one or more of a bet level or an odds of occurrence of the specific outcome pattern.

15. The gaming system of claim 11, wherein the electronic processor configured to execute instructions to cause the operation to animate the interim prize award value is configured execute instructions to cause the gaming system to perform operations to:
determine an amount of the interim prize award value based on the type of the selected bet pattern.

16. The gaming system of claim 14, wherein the electronic processor configured to execute instructions to cause the operation to animate the interim prize pattern is configured execute instructions to cause the gaming system to perform operations to overlay a highlighting effect over one or more spaces of the set of bingo cards that correspond to an equivalent location of the at least one of the one or more respective entries of the prize pattern index.

17. The gaming system of claim 16, wherein the electronic processor configured to execute instructions to cause the operation to animate the interim prize pattern is configured execute instructions to cause the gaming system to perform operations to adjust a visual characteristic of the highlighting effect based on the type of the selected bet pattern.

18. The gaming system of claim 11, wherein the interim draw mapping is a one-to-one correlation of each of the plurality of predetermined outcome patterns to a respective unique index value on the prize pattern index.

19. The gaming system of claim 11, wherein the specific outcome pattern is at least one of the plurality of predetermined outcome patterns that was mapped, wherein the interim draw mapping includes a one-to-many correlation of specific outcome patterns to multiple index values on the prize pattern index, and wherein the one-to-many correlation is based on the specific outcome pattern being associated with more than one type of bet pattern available for the wagering game.

20. The gaming system of claim 11, wherein detection of the specific outcome pattern of the randomizing device is in response to computerized analysis of image data captured of the randomizing device at a gaming table.
